(19) United States
(12) Patent Application Publication
(10) Pub. No.: US 2020/0184072 A1
(43) Pub. Date: Jun. 11, 2020

(54) ANALYSIS DEVICE, LOG ANALYSIS METHOD, AND RECORDING MEDIUM

(71) Applicant: NEC Corporation, Tokyo (JP)

(72) Inventor: Satoshi IKEDA, Tokyo (JP)

(73) Assignee: NEC Corporation, Tokyo (JP)

(21) Appl. No.: 16/624,667

(22) PCT Filed: Jun. 23, 2017
(86) PCT No.: PCT/JP2017/023136

§ 371 Date: Dec. 19, 2019

(51) Int. Cl. G06F 21/56; G06N 20/00; G06N 5/04; G06N 5/02

(52) U.S. Cl. CPC G06F 21/565; G06N 20/00; G06F 2221/034; G06N 5/02; G06N 5/04

(57) ABSTRACT

Provided is an analysis device including: feature extraction means configured to be able to, by use of a first feature value extracted from a first log entry being a log entry in which information indicating an action of a software program is recorded and a second feature value being different from the first feature value and being extracted from one or more second log entries being log entries, generate feature information related to the first log entry; and analysis model generation means configured to, by use of learning data including one or more sets of the feature information related to the first log entry and importance level information indicating an importance level assigned to the first log entry, generate an analysis model capable of determining an importance level related to another log entry.

### TECHNICAL FIELD

The present invention relates to a technology of analyzing a log.

### BACKGROUND ART

As a technology of detecting and analyzing an activity of a software program, a technology of analyzing a log recorded upon execution of the software program can be used.

For example, the following patent literatures are known as technologies related to log analysis.

PTL 1 describes a technology of presenting, to a user, an operation screen for setting a condition for filtering (restricting) records of logs related to an information system.

PTL 2 describes a technology of calculating a value of an electronic file from a model being generated for each user and representing an importance level of an operation with respect to the electronic file, and information indicating an operation executed on the electronic file by a user.

### CITATION LIST

### Patent Literature

PTL 1: Japanese Unexamined Patent Application Publication No. 2010-218313

PTL 2: Japanese Unexamined Patent Application Publication No. 2010-204824

### SUMMARY OF INVENTION

### Technical Problem

For example, the technology of analyzing a log is also applicable to analysis of a malicious software program (such as malware). In this case, by analyzing a log recorded according to an activity of a software program, an analyst examines whether or not the software program executes a malicious activity. A software program to be analyzed may be hereinafter described as a sample.

Many logs may be recorded for some samples. Further, it is not necessarily easy to learn a technical knowledge related to security, and it may be difficult to suitably analyze a log, depending on experience and a skill level of an analyst. In other words, there is a problem that it may be difficult for an analyst to determine an important part to be focused on in a recorded log.

On the other hand, the technology described in aforementioned PTL 1 is a technology for manually setting log filtering by a user. Further, the technology described in aforementioned PTL 2 is a technology of determining a value of an electronic file, based on an operation and a valuation by a user with respect to the electronic file. In other words, the technologies described in the patent literatures described above are not technologies capable of resolving the aforementioned problem.

The technology according to the present disclosure has been developed in view of such circumstances. Specifically, a main object of the present disclosure is to provide a technology capable of suitably determining importance of a log.

### Solution to Problem

In order to achieve above purpose, an aspect of an analysis device according to the present disclosure includes the following configuration. The aspect of the analysis device, according to the present disclosure, includes feature extraction means configured to be able to, by use of a first feature value extracted from a first log entry being a log entry in which information indicating an action of a software program is recorded and a second feature value being different from the first feature value and being extracted from one or more second log entries being log entries, generate feature information related to the first log entry; and analysis model generation means configured to, by use of learning data including one or more sets of the feature information related to the first log entry and importance level information indicating an importance level assigned to the first log entry, generate an analysis model capable of determining an importance level related to another log entry.

Another aspect of an analysis method according to the present disclosure includes the following configuration. Another aspect of the analysis method, according to the present disclosure, includes, by use of a first feature value extracted from a first log entry being a log entry in which information indicating an action of a software program is recorded and a second feature value being different from the first feature value and being extracted from one or more second log entries being log entries, generating feature information related to the first log entry; and, by use of learning data including one or more sets of the feature information related to the first log entry and importance level information indicating an importance level assigned to the first log entry, generating an analysis model capable of determining an importance level related to another log entry.

Further, the aforementioned object is also achieved by a computer program (analysis program) providing the analysis device, the analysis method, and the like having the aforementioned configurations by a computer, and a computer-readable recording medium or the like having the computer program stored thereon.

Another aspect of an analysis program according to the present disclosure includes the following configuration. Another aspect of the analysis program, according to the present disclosure, causes a computer to execute: processing of, by use of a first feature value extracted from a first log entry being a log entry in which information indicating an action of a software program is recorded and a second feature value being different from the first feature value and being extracted from one or more second log entries being log entries, generating feature information related to the first log entry; and processing of, by use of learning data including one or more sets of the feature information related to the first log entry and importance level information indicating an importance level assigned to the first log entry, generating an analysis model capable of determining an importance level related to another log entry.

Further, the aforementioned computer program may be recorded in an aspect of a recording medium according to the present disclosure.

### Advantageous Effects of Invention

The present disclosure is able to suitably determine importance of a log.

### BRIEF DESCRIPTION OF DRAWINGS

FIG. 1 is a block diagram illustrating a functional configuration of an analysis device according to a first example embodiment of the present disclosure.

FIG. 2 is a diagram illustrating a specific example of a log.

FIG. 3 is a diagram illustrating an outline of a process of generating feature information from a log.

FIG. 4 is a diagram illustrating a specific example of training data.

FIG. 5 is a diagram illustrating a specific example of a log set with a training label.

FIG. 6 is a flowchart illustrating an operation example of the analysis device according to the first example embodiment of the present disclosure.

FIG. 7 is a block diagram illustrating a functional configuration of an analysis device according to a second example embodiment of the present disclosure.

FIG. 8 is a block diagram illustrating another functional configuration of the analysis device according to the second example embodiment of the present disclosure.

FIG. 9 is a block diagram illustrating yet another functional configuration of the analysis device according to the second example embodiment of the present disclosure.

FIG. 10 is a diagram illustrating a specific example of a log according to the second example embodiment of the present disclosure.

FIG. 11 is a diagram illustrating a specific example of training data according to the second example embodiment of the present disclosure.

FIG. 12 is a diagram illustrating a specific example of a first feature value according to the second example embodiment of the present disclosure.

FIG. 13 is a diagram illustrating a specific example of a second feature value according to the second example embodiment of the present disclosure.

FIG. 14 is a diagram illustrating another specific example of a second feature value according to the second example embodiment of the present disclosure.

FIG. 15 is a diagram illustrating yet another specific example of a second feature value according to the second example embodiment of the present disclosure.

FIG. 16 is a diagram illustrating yet another specific example of a second feature value according to the second example embodiment of the present disclosure.

FIG. 17 is a diagram illustrating an outline of a learning phase and an evaluation phase of an analysis model according to the second example embodiment of the present disclosure.

FIG. 18 is a diagram illustrating a specific example of a user interface generated by the analysis device according to the second example embodiment of the present disclosure.

FIG. 19 is a diagram illustrating another specific example of a user interface generated by the analysis device according to the second example embodiment of the present disclosure.

FIG. 20 is a diagram illustrating yet another specific example of a user interface generated by the analysis device according to the second example embodiment of the present disclosure.

FIG. 21 is a flowchart illustrating an operation example of the analysis device according to the second example embodiment of the present disclosure.

FIG. 22 is a block diagram illustrating a functional configuration of an analysis device in a modified example 1 of the second example embodiment of the present disclosure.

FIG. 23 is a diagram illustrating an outline of a process of generating feature information by use of external context information in the modified example 1 of the second example embodiment of the present disclosure.

FIG. 24 is a flowchart illustrating an operation example of the analysis device in the modified example 1 of the second example embodiment of the present disclosure.

FIG. 25 is a block diagram illustrating a functional configuration of an analysis device in a modified example 2 of the second example embodiment of the present disclosure.

FIG. 26 is a block diagram illustrating a functional configuration of an analysis device in a modified example 3 of the second example embodiment of the present disclosure.

FIG. 27 is a block diagram illustrating a configuration of a hardware device capable of providing the analysis device according to each example embodiment of the present disclosure.

### EXAMPLE EMBODIMENT

Prior to detailed description of each example embodiment, technical considerations and the like in the present disclosure will be described. For convenience of description, malicious software programs are hereinafter collectively described as malware.

For example, a signature-based analysis technology and a sandbox-based analysis technology are known as technologies of detecting and analyzing an activity of malware.

In the signature-based analysis technology, data and an action pattern to be detected are predefined as signatures. For example, when data related to a sample or a behavior of the sample matches a signature, the sample is detected as malware.

Since the signature-based analysis technology may not cope with various types of malware (including new species and subspecies), the sandbox-based analysis technology may be used.

A sandbox is a protected and isolated environment in which a sample to be analyzed can be executed. For example, a sandbox may be provided by use of a virtual environment. An action of a sample in a sandbox does not affect outside the sandbox. Accordingly, in the sandbox-based analysis technology, for example, by executing a sample in a sandbox and monitoring the action, an analysis result related to the sample can be generated.

When a sample is analyzed by use of the sandbox-based analysis technology, for example, a determination result of whether or not the sample is malware, a summary related to an action of the sample, and a log of an action (action log) of the sample are acquired as an analysis result.

On the other hand, reliability of an analysis result by the sandbox-based analysis technology may not necessarily be sufficient. For example, a highly reliable analysis result may not necessarily be acquired for an unknown sample such as a new type of malware being customized.

In such a situation, for example, an analyst examines a behavior of a sample by checking, in detail, a log acquired by executing the sample in a sandbox environment. Since a number and a frequency of recorded logs vary by sample, an analyst is required to check an important log out of a large number of logs in some cases. Further, in order to determine an importance level of a log, an analyst is required to consider various factors such as relevance between logs, an output sequence of logs, and a number and a frequency of logs having a specific feature. Log analysis is not necessarily easy for an analyst due to constraints such as the time required for analysis and experience (skill level) of the analyst.

In view of the aforementioned situation, the present applicant has arrived at an idea of the technology according to the present disclosure being a technology capable of suitably determining an importance level of a log without depending on manual work.

For example, the technology according to the present disclosure described below may include a configuration of using, as learning data, a log in which an action of a software program is recorded and information indicating an importance level of the log, in order to learn a model capable of determining an importance level of another log. Further, the technology according to the present disclosure may include a configuration of using a feature value acquired from one log entry constituting a log and a feature value indicating a context of the log, in order to generate feature information related to the one entry. A log entry and a context of a log will be described later. Further, for example, the technology according to the present disclosure may include a configuration capable of controlling a method of presenting an analyst with a log, based on an importance level of a log determined by use of a learned model.

The technology according to the present disclosure including the configurations as described above can suitably determine importance of a log without depending on manual work of an analyst by, for example, determining an importance level of the log by use of a learned model.

Further, the technology according to the present disclosure can control a method of presenting an analyst with a log, based on importance of the log. Consequently, for example, the analyst can proceed with analysis of a sample while focusing on a log with relatively high importance out of a large number of logs.

The technology according to the present disclosure will be described in more detail below by use of specific example embodiments. Configurations of the following specific example embodiments (and modified examples thereof) are exemplifications and do not limit the technical scope of the technology according to the present disclosure. Allocation (for example, function-based allocation) of components constituting each of the following example embodiments is an example by which the example embodiment can be provided. Configurations by which the respective example embodiments can be provided are not limited to the following exemplifications, and various configurations may be assumed. A component constituting each of the following example embodiments may be further divided, and also one or more components constituting each of the following example embodiments may be integrated.

When each example embodiment exemplified below is provided by use of one or more physical devices or virtual devices, or a combination thereof, one or more components may be provided by one or more devices, and one component may be provided by use of a plurality of devices.

### First Example Embodiment

A first of the example embodiments (first example embodiment) capable of providing the technology according to the present disclosure will be described below. An analysis device described below may be implemented as a single device (a physical or virtual device) or may be implemented as a system using a plurality of separate devices (physical or virtual devices). When the analysis device is implemented by use of a plurality of devices, the devices may be communicably connected to one another by a wired or wireless communication network, or a suitable combination thereof. A hardware configuration capable of providing the analysis device described below will be described later.

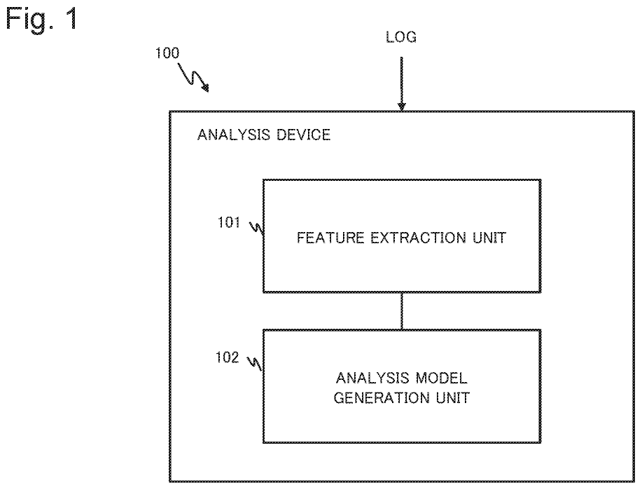

FIG. 1 is a block diagram conceptually illustrating a functional configuration of an analysis device 100 according to the present example embodiment.

As illustrated in FIG. 1, the analysis device 100 according to the present example embodiment includes a feature extraction unit 101 (feature extraction means) and an analysis model generation unit 102 (analysis model generation means). The components constituting the analysis device 100 may be communicably connected to one another by use of a suitable communication method.

The analysis device 100 is provided with a log in which information about an action of a software program (sample) is recorded.

For example, a log may include information indicating various types of processing (for example, an application programming interface [API] call, file access, process control [such as startup and completion], communication processing, registry access, and a system call) executed by a software program.

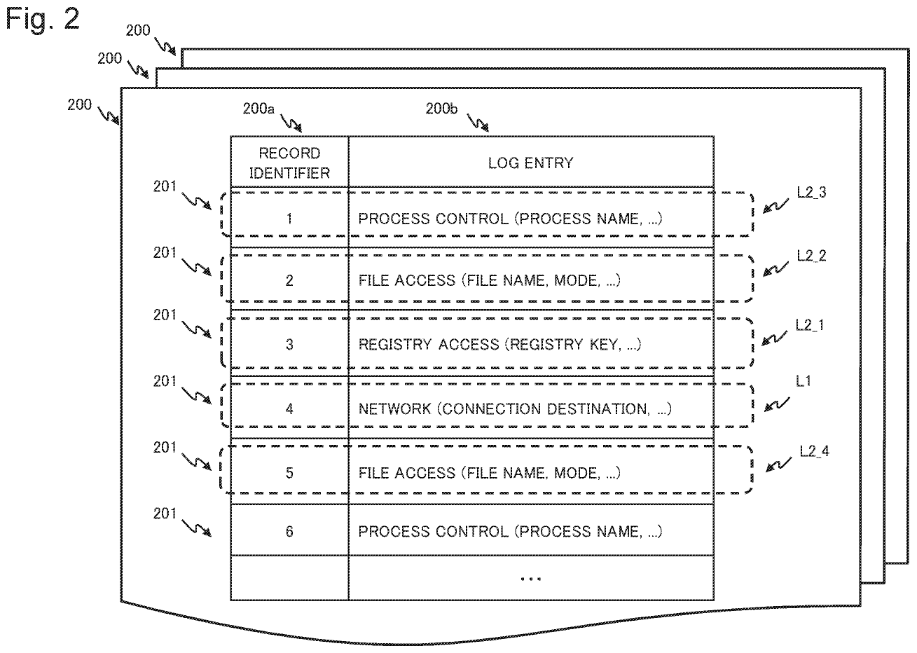

FIG. 2 illustrates an example of a log. The log illustrated in FIG. 2 is a specific example for convenience of description and does not limit the technology according to the present disclosure.

One or more records each including a record identifier 200a and a log entry 200b are recorded in a log 200. An individual record included in the log 200 is action information indicating an action of a software program observed by execution of a software program. Six records are illustrated in the specific example illustrated in FIG. 2.

For example, the record identifier 200a is an identifier allowing identification of a record included in a log. Information allowing identification of a sequence (order) of actions of the software program may be recorded in the record identifier 200a. For example, information allowing identification of a timing of execution of each type of processing (such as information indicating a time or an elapsed time) may be recorded in the record identifier 200a.

Information indicating details of processing (an action of the software program) executed by the software program is recorded in the log entry 200b. Information recorded in the log entry 200b is not particularly limited, and suitable information is recorded, based on processing executed by the software program. For example, the log entry 200b may appropriately include information allowing identification of processing executed by the software program, information indicating data used in the processing, and information allowing identification of a target of the processing.

Each component in the analysis device 100 will be described below.

From one or more records included in a log (for example, a log 200) in which an action of a software program is recorded, the feature extraction unit 101 generates feature information indicating the record (a log entry included in the record, in particular). Specifically, the feature extraction unit 101 selects (specifies) one record used as learning data in the log 200 and extracts a feature value indicating a feature of the log entry. A log entry in a record used as learning data may be hereinafter described as a “first log entry” and a feature value extracted from the log entry may be described as a “first feature value.”

A first feature value according to the present example embodiment is not particularly limited, and a suitable feature value may be selected, based on a format, a content, and the like of a first log entry. For example, when information recorded in a first log entry is expressed by a string representation, a first feature value may be a feature value that may be extracted from the character string. For example, a first feature value may be a feature value expressing information recorded in a first log entry as a numerical value. A first feature value may be expressed as a vector (feature vector) composed of one or more elements.

The feature extraction unit 101 extracts a feature value different from a first feature value (may be described as a “second feature value”) from one or more records included in a log (for example, a log 200). A log entry in a record used for generation of a second feature value is hereinafter described as a “second log entry.” In the specific example illustrated in FIG. 2, the feature extraction unit 101 selects (specifies) one or more records included in the log 200 and extracts a second feature value, based on log entries (second log entries) in the records. A second feature value may be a feature value different from a first feature value.

For example, a second log entry may be a log entry a recorded content of which satisfies a specific criterion. One or more of criteria exemplified below may be used as a specific example of such a criterion but the specific example is not limited thereto.

(1) A log entry recorded in an execution process of the same software program

(2) A log entry related to the same process executed in an execution process of a software program

(3) A log entry recorded at a timing adjacent to a timing when a log entry is recorded

A log entry in one record may be used for only either one of a first log entry and a second log entry, or may be used for both. The feature extraction unit 101 may extract a second log entry from a log 200 including a first log entry or may specify a second log entry from another log 200 not including the first log entry.

For example, a second feature value is a feature value being extracted based on one or more second log entries included in a log and indicating a context of the log. For example, a context may be background information related to a log or information indicating a comprehensive feature of a log. A second feature value may be expressed as a vector (feature vector) composed of one or more elements.

By use of a first feature value extracted from one first log entry included in a log and a second feature value extracted from one or more second log entries included in the log, the feature extraction unit 101 generates feature information related to the first log entry. In other words, feature information of a first log entry includes a feature value directly extracted from the first log entry and a feature value being extracted based on one or more second log entries and indicating a context of the log. When a first feature value and a second feature value are expressed as feature vectors, feature information of a first log entry may be expressed as a vector (feature vector) including every element in the feature vectors.

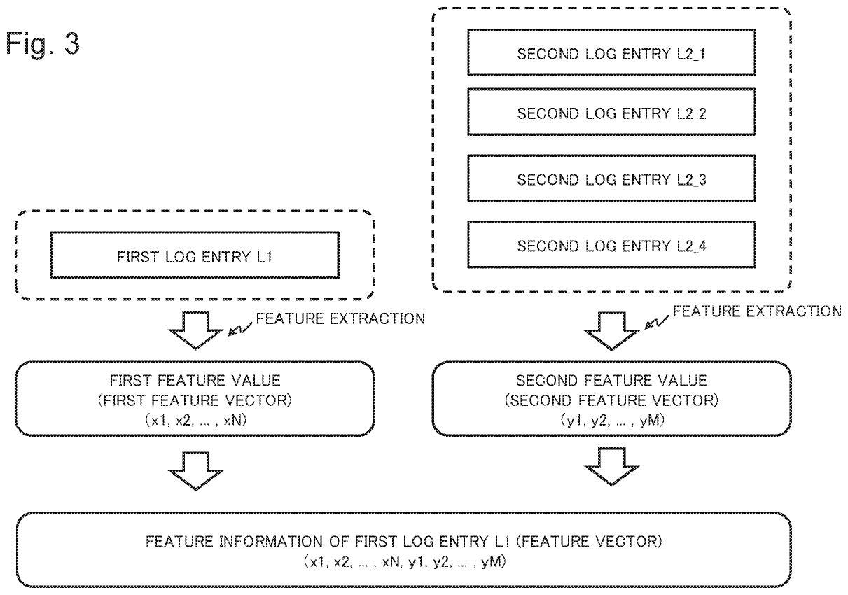

It is assumed in the specific example illustrated in FIG. 2 that a record 201 given with a sign “L1” is a record including a first log entry (hereinafter described as a “first log entry L1”), and records given with signs “L2_1” to “L2_4” are second log entry (hereinafter described as a “second log entry L2_1” and so forth) records. A process of generating feature information related to the first log entry L1 from the log 200 illustrated in FIG. 2 will be described below with reference to FIG. 3.

The feature extraction unit 101 extracts a first feature value related to the first log entry L1 from the first log entry L1. In FIG. 3, the first feature value is expressed as an “N”-dimensional (where “N” is a natural number) feature vector (first feature vector) including elements “x1” to “xN.”

The feature extraction unit 101 extracts a second feature value related to the first log entry L1 from the second log entry L2_1 to the second log entry L2_4. In FIG. 3, the second feature value is expressed as an “M”-dimensional (where “M” is a natural number) feature vector (second feature vector) including elements “y1” to “yM.”

By use of the extracted first feature value and second feature value, the feature extraction unit 101 generates feature information related to the first log entry L1. In FIG. 3, the feature information related to the first log entry L1 is expressed as an “M+N”-dimensional feature vector including elements “x1” to “xN” and “y1” to “yM.” Note that an order of elements in a feature vector is not particularly limited. As illustrated in FIG. 3, the feature extraction unit 101 may arrange the elements of the first feature vector and the elements of the second feature vector in series or may arrange the elements in another order.

The feature extraction unit 101 may provide the analysis model generation unit 102 with feature information generated for one or more first log entries included in a log, as learning data.

By use of feature information related to a log entry generated by the feature extraction unit 101 and importance level information indicating an importance level of the log entry, the analysis model generation unit 102 generates an analysis model capable of determining an importance level related to another log entry. Specifically, for example, by using feature information related to a plurality of first log entries and importance level information as learning data (training data), the analysis model generation unit 102 executes processing of learning (training) an analysis model (to be described later).

It is assumed in the present example embodiment that importance level information is previously provided as training data for each log entry used as learning data. For example, by a well-experienced (highly skilled) analyst setting importance level information to each log entry used as learning data, a suitable importance level can be assigned to each log entry. It may be also considered that learning data including thus generated feature information and training data including importance level information reflect knowledge of an analyst. It may be considered that an analysis model trained by use of such learning data and training data can determine an importance level of each log entry, based on the knowledge of the analyst.

Importance level information indicating an importance level of a log entry corresponds to a training label assigned to a log entry used as learning data. A specific expression method of importance level information is not particularly limited. For example, importance level information may be expressed by use of some labels (for example “high,” “medium,” and “low”) or may be expressed by use of numerical values. For example, importance level information may be expressed by use of discrete values (for example, “unimportant: 0” and “important: 1”) or may be expressed by use of continuous values in a range.

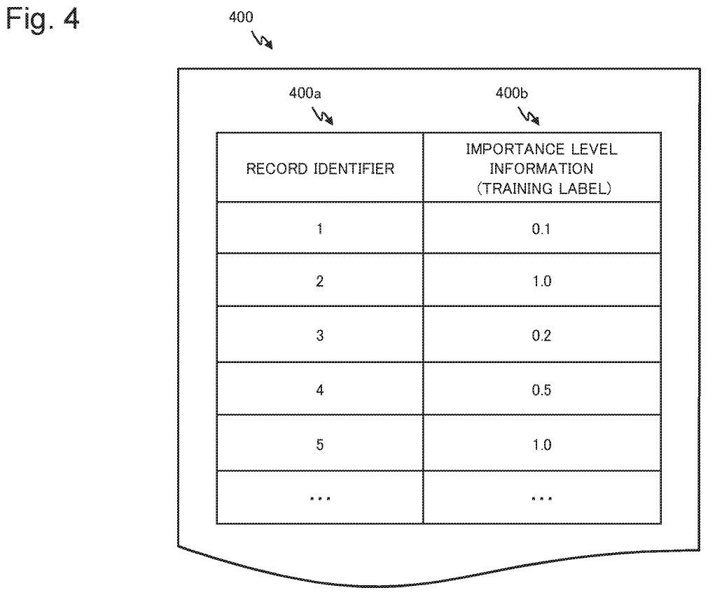

It is assumed in the present example embodiment that training data including importance level information associated with a log entry used as learning data are provided for the analysis device 100 (the analysis model generation unit 102 in particular). FIG. 4 is a diagram illustrating a specific example of training data in this case. The training data illustrated in FIG. 4 include information specifying each log entry illustrated in FIG. 2 (record identifier 400a) and importance level information assigned to each log entry (importance level information 400b).

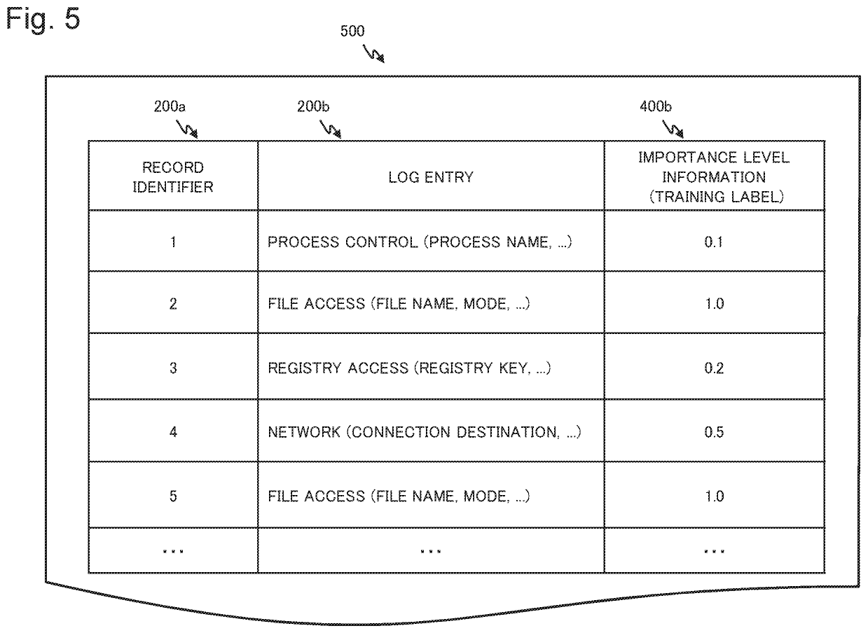

Without being limited to the above, for example, a log including importance level information related to a first log entry may be provided as learning data including training data. FIG. 5 is a diagram illustrating a specific example in this case. A log 500 illustrated in FIG. 5 is changed from the log 200 illustrated in FIG. 2 in such a way as to include importance level information 400b.

According to the present example embodiment, training data including importance level information as described above may be previously (for example, with a log) given to the analysis device 100. Further, the analysis device 100 may refer to training data stored in another device.

An analysis model is a model receiving feature information related to a log entry as an input and being capable of determining an importance level of the log entry. For example, various types of models (for example, a support vector machine [SVM], a multilayer neural network [NN], gradient boosted trees, and random forests) used in the fields of supervised machine learning and pattern recognition may be employed as an analysis model. Note that the present example embodiment is not limited to the aforementioned exemplifications, and an analysis model employing another algorithm may be employed.

By use of feature information being related to a first log entry and being provided from the feature extraction unit 101, and training data, the analysis model generation unit 102 executes a learning algorithm suitable for learning an analysis model. Consequently, an analysis model capable of determining an importance level related to a log entry is learned.

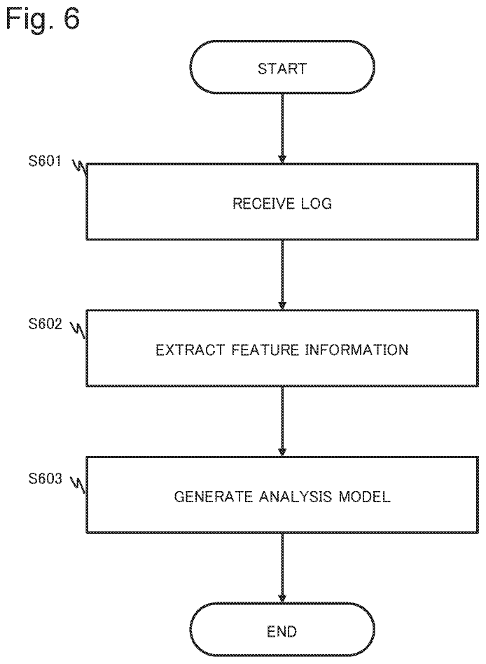

An operation of the analysis device 100 configured as described above will be described with reference to a flowchart illustrated in FIG. 6.

The analysis device 100 receives a log in which information about an action of a software program is recorded (Step S601).

From the received log, the analysis device 100 generates feature information related to each log entry used as learning data (Step S602). At this time, the feature extraction unit 101 extracts a first feature value from one first log entry and extracts a second feature value from one or more second log entries. By use of the first and second feature values, the feature extraction unit 101 generates feature information related to the one log entry. The feature extraction unit 101 may provide the generated feature information for the analysis model generation unit 102 as learning data.

By use of learning data including feature information of a log entry and training data including importance level information assigned to the log entry, the analysis device 100 executes learning processing of an analysis model. Consequently, the analysis device 100 can generate an analysis model capable of determining an importance level related to a log entry.

The analysis device 100 according to the present example embodiment configured as described above can suitably determine importance of a log. The reason is as follows.

The analysis device 100 generates feature information related to a log entry included in a log used as learning data. The analysis device 100 learns an analysis model by use of learning data including feature information generated as described above and training data including importance level information assigned to the log entry. By using an analysis model learned as described above, the analysis device 100 can determine, for example, an importance level of a log entry not included in the learning data.

For example, it may be considered that, by learning an analysis model by use of training data generated by a well-experienced analyst, an analysis model reflecting knowledge of the analyst can be generated. It may be considered that an importance level of a log entry can be more suitably determined by using such an analysis model.

Further, by use of a first feature value extracted from one log entry included in a log and a second feature value indicating a context of the log and being extracted based on one or more log entries, the analysis device 100 according to the present example embodiment generates feature information related to the one log entry. In other words, feature information related to the one log entry reflects the context of the log.

When determining importance of a log entry, an analyst may check not only a single log entry but also an overall picture of information recorded in a log, contents of adjacent log entries, a content of another log entry related to information recorded in the log entry, and the like. Thus, it may be considered that, by checking not only a single log entry but also a context of the log, importance of a log entry can be more suitably determined.

On the other hand, the analysis device 100 according to the present example embodiment can generate feature information including a feature value extracted from one log entry and a feature value extracted from a context related to the log. In other words, it may be considered that, by using feature information reflecting a context of a log, the analysis device 100 can generate an analysis model capable of more suitably determining importance of a log entry.

### Second Example Embodiment

A second of the example embodiments of the technology according to the present disclosure (second example embodiment) based on the aforementioned first example embodiment will be described below.

### Configuration of Analysis Device 700

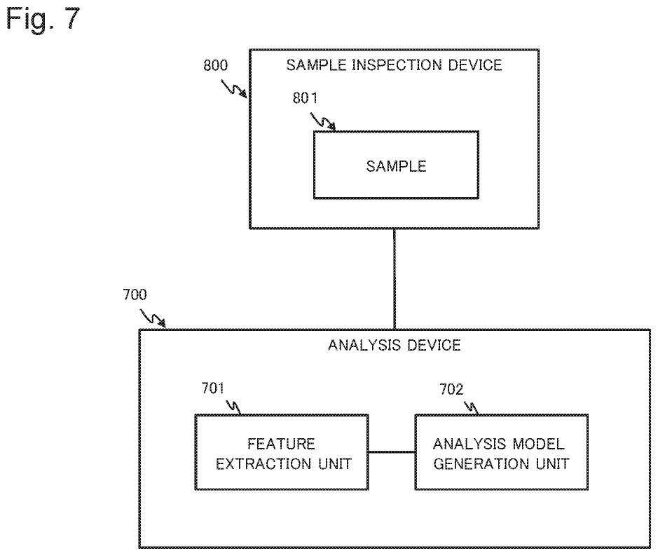

FIG. 7 is a block diagram conceptually illustrating a functional configuration of an analysis device 700 according to the present example embodiment. The analysis device 700 is a device analyzing a log generated by execution of a software program to be examined (a “sample” to be described later).

A sample inspection device 800 is a device capable of dynamically analyzing a sample 801 by executing the sample 801 in an isolated environment by use of a sandbox-based technology. For example, the sample inspection device 800 may be provided by use of a security appliance product or the like, or may be provided by use of an information processing device such as a computer in which a software program providing a sandbox environment is introduced.

The sample inspection device 800 has a function of detecting processing executed by the sample 801 (that is, an action of the sample 801). For example, actions of the sample 801 detectable by the sample inspection device 800 may include a call for a specific application programming interface (API), a call for a system call, a code injection, generation of an executable file, execution of a script file, suspension of a specific service, file access, registry access, and communication with a specific communication destination.

The sample inspection device 800 records an action of the sample 801 detected in a process of sample analysis as a log (action log) and provides the log for the analysis device 700. A specific content of a log provided by the sample inspection device 800 will be described later.

The sample inspection device 800 may provide the analysis device 700 with information other than a log acquired by analyzing the sample 801. For example, information other than a log may include a primary determination result of whether or not the sample 801 is malware. Further, for example, such information may include a summary related to actions of the sample 801 (a summary related to a malicious behavior, startup and completion of a process, file access, communication, registry access, an API call, and the like).

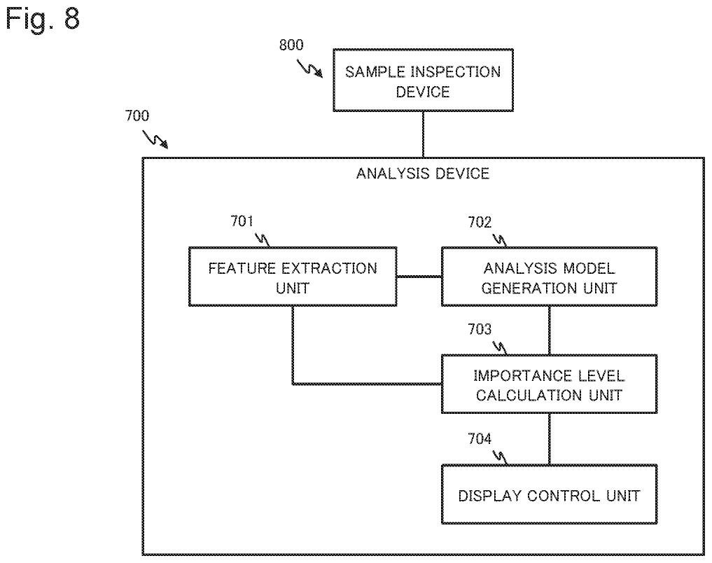

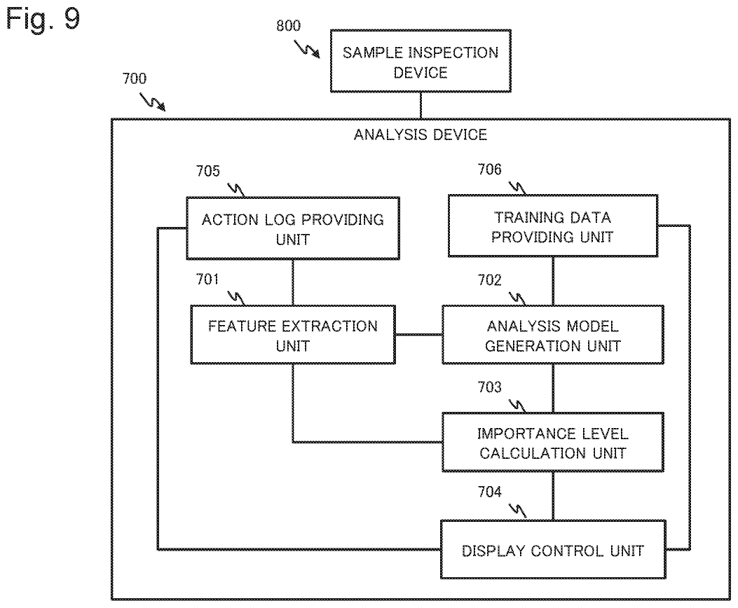

A specific configuration of the analysis device 700 according to the present example embodiment will be described below. The analysis device 700 includes a feature extraction unit 701 (feature extraction means) and an analysis model generation unit 702 (analysis model generation means) as a basic configuration. For example, as illustrated in FIG. 8, the analysis device 700 may further include an importance level calculation unit 703 (importance level calculation means) and a display control unit 704 (display control means). For example, as illustrated in FIG. 9, the analysis device 700 may further include an action log providing unit 705 (log providing means) and a training data providing unit 706 (training data providing means). The components may be communicably connected to one another by use of a suitable communication method. Each component will be described below.

For log entries in one or more records included in a log provided by the sample inspection device 800, the feature extraction unit 701 generates feature information indicating the log entries. The feature extraction unit 701 generates feature information related to a log entry by use of a first feature value extracted from a first log entry and a second feature value extracted from a plurality of second log entries, similarly to the feature extraction unit 101 according to the first example embodiment. A specific example of each feature value will be described later.

When the analysis device 700 includes the action log providing unit 705, to be described later, the feature extraction unit 701 may acquire a log from the action log providing unit 705.

The feature extraction unit 701 may generate feature information related to a log entry in a record an importance level of which is to be evaluated in a log and provide the feature information for the importance level calculation unit 703 as data to be evaluated.

By use of feature information related to a log entry generated by the feature extraction unit 701 and importance level information (training data) indicating an importance level of the log entry, the analysis model generation unit 702 generates an analysis model capable of determining an importance level related to another log entry.

Specifically, for example, the analysis model generation unit 702 executes processing of learning (training) an analysis model (to be described later) by use of learning data including feature information related to a plurality of first log entries and training data including importance level information, similarly to the analysis model generation unit 102 according to the first example embodiment. The analysis model according to the present example embodiment will be described later.

When the analysis device 700 includes the training data providing unit 706, to be described later, the analysis model generation unit 702 may acquire training data from the training data providing unit 706. Further, the analysis model generation unit 702 may provide a generated analysis model for the importance level calculation unit 703.

The importance level calculation unit 703 calculates an importance level of a log entry included in a log by use of an analysis model generated in the analysis model generation unit 702. Specifically, by giving feature information generated for a log entry to the analysis model as an input, the importance level calculation unit 703 calculates an importance level related to the log entry. A specific method for calculating an importance level will be described later. The importance level calculation unit 703 provides the display control unit 704 with an importance level calculated for a log entry.

The display control unit 704 controls a display method of a log related to a sample, based on an importance level calculated in the importance level calculation unit 703. For example, the display control unit 704 may acquire a log related to a sample from the action log providing unit 705, to be described later, and receive an importance level related to a log entry included in the log from the importance level calculation unit 703.

Specifically, for example, the display control unit 704 generates data (hereinafter described as “display data”) used in display of a user interface allowing control of whether or not to display each log entry included in a provided log. For example, such a user interface may include a control element allowing control of a display method of a log entry, based on an importance level of the log entry. The display control unit 704 may present such a user interface to a user of the analysis device 100 by providing display data for a suitable display device (such as various monitor screens and a panel). A specific configuration of the display device is not particularly limited and may be appropriately selected. The display device may be provided inside the analysis device 700 or outside the analysis device 700.

Without being limited to the above, the display control unit 704 may provide display data for an external device connected through a communication network. A specific example of display data generated by the display control unit 704 will be described later.

The action log providing unit 705 receives a log recorded in a process of executing the sample 801 from the sample inspection device 800 and keeps (stores) the log. The action log providing unit 705 may provide a log for the feature extraction unit 701 and the display control unit 704 in response to a request from the units.

The training data providing unit 706 keeps (stores) importance level information assigned to a log entry included in a log. For example, the training data providing unit 706 may be previously provided with training data by a user of the analysis device 700 or the like. For example, as described above, such training data may include information indicating an importance level related to a log determined by an analyst through manual work.

For example, the training data providing unit 706 may store information allowing identification of a log entry used as learning data and importance level information previously set for the log entry by an analyst or the like in association with one another.

For example, the training data providing unit 706 may provide importance level information related to a log entry as training data in response to a request from the analysis model generation unit 702. Further, the training data providing unit 706 may provide importance level information related to a log entry in response to a request from the display control unit 704.

### Content of Log

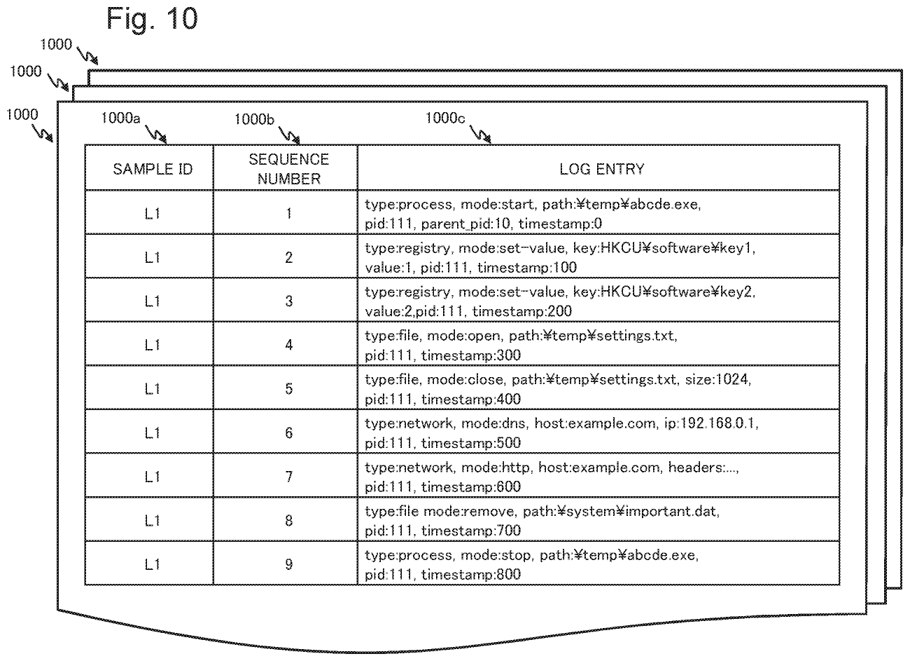

A log recorded in the sample inspection device 800 will be described below. FIG. 10 is a diagram illustrating an example of a log (log 1000) recorded in the sample inspection device 800.

As illustrated in FIG. 10, for example, the log 1000 includes one or more records (lines) in which information indicating processing executed by a software program is recorded. For example, a record in the log 1000 includes a sample ID 1000a, a sequence number 1000b, and a log entry 1000c for each log entry.

The sample ID 1000a is an identifier (ID) allowing identification of an executed sample. The sequence number 1000b is information allowing identification of a sequence (order) in which log entries are recorded. Non-overlapping values may be set to the sequence numbers 1000b for each sample identified by the sample ID 1000a.

Suitable information is recorded in the log entry 1000c depending on processing executed by the sample. The log entry 1000c may include one or more fields. Information recorded in each field constituting the log entry 1000c is not particularly limited, and for example, information as described below may be recorded.

A “type” field may be recorded in the log entry 1000c as information allowing identification of a type of processing executed by the sample (hereinafter described as a “log type”). For example, the “type” field indicating a log type may include file access (“type: file”), process control (“type: process”), registry access (“type: registry”), and communication processing (“type: network”). Information other than the above may be set to a log type.

Information (a “mode” field) indicating specific execution details of processing specified by a log type may be recorded in the log entry 1000c. For example, when a log type is process control (“type: process”), information indicating a start (“start”) and a stop (“stop”) of a process may be set to the “mode” field. For example, when a log type is file access (“type: file”), information indicating file open (“open”) and close (“close”) may be set to the “mode” field. For example, when a log type is registry access (“type: registry”), information indicating value setting to a registry (“set-value”) may be set to the “mode” field. For example, when a log type is communication processing (“type: network”), information indicating information allowing identification of a protocol related to communication processing (for example, “dns” or “http”) may be set to the “mode” field.

For example, information indicating a resource related to processing executed by the sample and a parameter used in the processing may be recorded in the log entry 1000c. In the specific example illustrated in FIG. 10, for example, information indicating an executed file and an accessed file path is recorded in a “path” field. Information indicating a registry key is recorded in a “key” field. Information indicating a value set to a registry is recorded in a “value” field. Information allowing identification of a communication destination is recorded in a “host” field. Information indicating an Internet Protocol (IP) address of a communication destination is recorded in an “ip” field. Information indicating a header included in data transmitted and received in accordance with a communication protocol is recorded in a “headers” field.

For example, information (a “pid” field) allowing identification of a process executing processing of outputting a log entry may be recorded in the log entry 1000c.

For example, information (a “timestamp” field) allowing identification of a timing (for example, a time or an elapsed time) at which a log entry is recorded may be recorded in the log entry 1000c.

Part of the fields exemplified above may be recorded in the log entry 1000c, and a field other than the fields exemplified above may be recorded.

For example, a record with a sequence number “1” described in FIG. 10 indicates that a process executing an executable file “\temp\abcde.exe” is started. A record with a sequence number “9” indicates that the process for “\temp\abcde.exe” is stopped. Further, each of records with sequence numbers “2” and “3” indicates that a value specified by “value” is set to a specific registry key specified by “key.” Further, each of records with sequence numbers “4,” “5,” and “8” indicates file access (file open, close, delete). Further, each of records with sequence numbers “6” and “7” indicates communication with a specific communication destination.

### Training Data

Training data provided for the analysis device 700 will be described below. As described above, when the analysis device 700 includes the training data providing unit 706, training data may be stored in the training data providing unit 706.

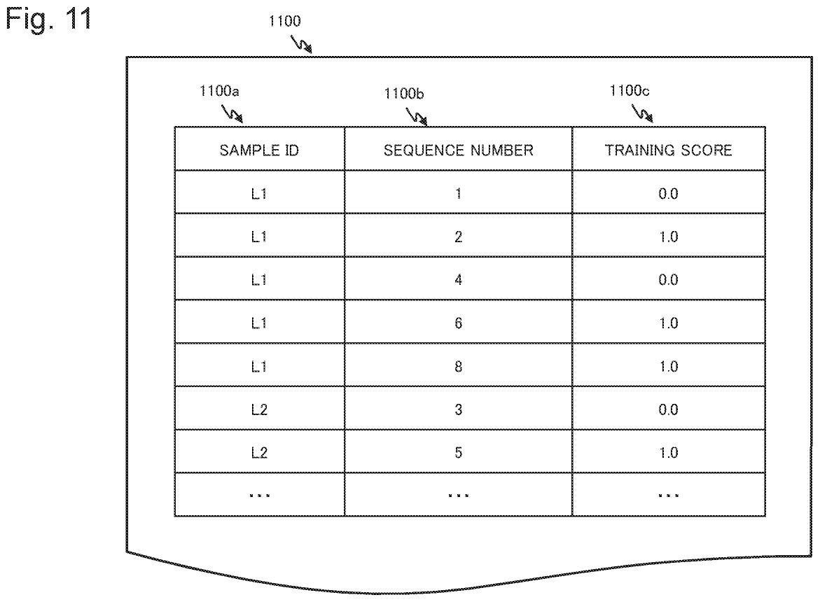

FIG. 11 is a diagram illustrating a specific example of training data according to the present example embodiment. As illustrated in FIG. 11, training data include one or more records (lines) each including a sample ID1100a, a sequence number 1100b, and a training score 1100c. The sample ID1100a is an identifier allowing identification of a sample 801, similarly to the sample ID 1000a illustrated in FIG. 10. Further, the sequence number 1100b is information allowing identification of a sequence (order) in which log entries are recorded, similarly to the sequence number 1000b illustrated in FIG. 10.

The training score 1100c indicates an importance level related to a log entry specified by the sample ID1100a and the sequence number 1100b. For example, continuous values in a specific range (for example, numerical values between “0.0” and “1.0”) may be set to training scores 1100c, based on an importance level. Further, a numerical value (for example, important: “1” or unimportant: “0”) or a label indicating important-unimportant may be set to the training score 1100c. The training score 1100c is used as a training label in a learning process of an analysis model, to be described later.

### First Feature Value

A first feature value extracted from a first log entry by the feature extraction unit 701 will be described below. It is assumed in the description below that, for convenience of description, data recorded in a log entry in a record are handled as data expressible by a character string or a numerical value. Further, in this case, the feature extraction unit 701 may appropriately convert information recorded in the first log entry into a character string and a numerical value.

As an example, a first feature value may indicate an appearance frequency of an N-gram in a case of a record in a log entry 1000c being expressed as a character string. An N-gram herein represents a contiguous sequence of one or more characters. For example, a unigram represents an arrangement of a one-character string, a 2-gram (bigram) represents an arrangement of a two-character string, and a 3-gram (trigram) represents an arrangement of a three-character string.

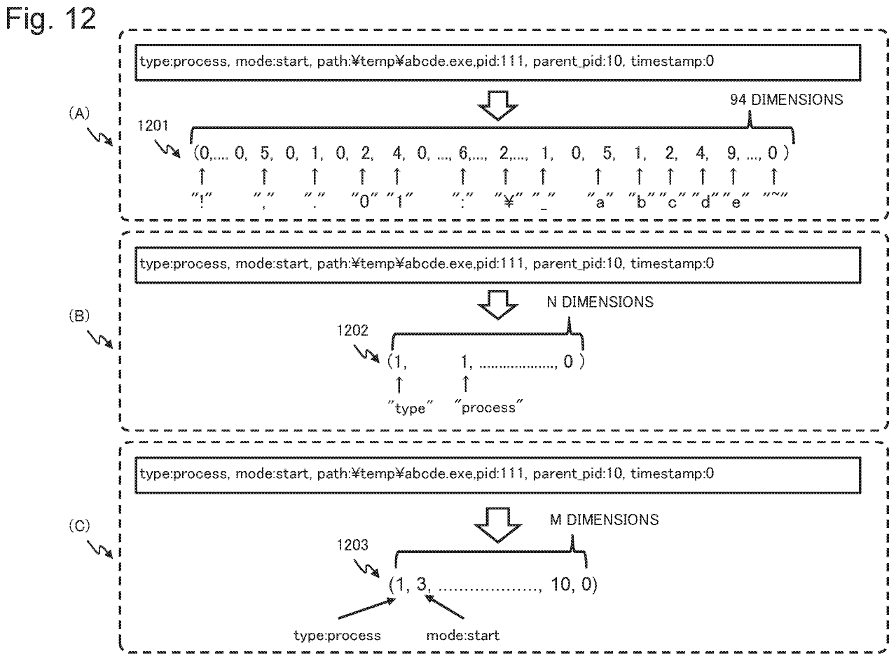

For example, it is assumed that the log entry 1000c is expressed as a character string expressible by printable characters (0x21 to 0x7E: 94 characters) based on the American Standard Code for Information Interchange (ASCII) code. When an appearance frequency (histogram) of one-character-based unigram (an arrangement of one character) is used as a feature value, a 94-dimensional feature value (feature vector) as indicated in a part (A) in FIG. 12 is acquired. Each element in the feature vector in the part (A) in FIG. 12 (1201 in FIG. 12) indicates a number of appearance of a character expressed by a specific ASCII code in a log entry. For an arrangement of two characters or more, a feature value can be extracted by a similar method. Further, the feature extraction unit 701 may use an appearance frequency of an N-gram for each field included in a log entry as a feature value. In this case, for example, an appearance frequency in the “mode” field or an appearance frequency in the “type” field is used as a feature value.

As another example, a first feature value may indicate an appearance frequency of each word when a log entry is divided into words by a specific delimiter (separator).

As an example, by use of a dictionary including words appearing in a log 1000, the feature extraction unit 701 may count a frequency of each word included in the dictionary appearing in a log entry. In this case, an “N”-dimensional (where “N” is a natural number) feature vector as indicated in a part (B) in FIG. 12 (1202 in FIG. 12) is acquired. N herein denotes a number of words included in the dictionary, and each element in the feature vector indicates an appearance frequency of each word included in the dictionary.

The dictionary may be previously provided for the analysis device 700. Further, the feature extraction unit 101 may generate the dictionary by selecting words from one or more logs by use of a suitable criterion. A separator is appropriately selectable, and, for example, a character such as “;” or “,” or “/” may be used as a separator.

In the specific example illustrated in FIG. 12, the first element of the feature vector 1202 indicates an appearance frequency of a word “type,” and the second element indicates an appearance frequency of a word “process.” Similarly, an appearance frequency of each word included in the dictionary is set to each element in the feature vector 1202.

As another example, the feature extraction unit 701 may calculate, for example, an index from a divided word. For example, the feature extraction unit 701 generates an “N”-dimensional feature vector (initial value for every element being “0”). Then, for example, the feature extraction unit 701 calculates a hash value of the divided word and calculates the remainder of the hash value by “N” (“0” to “N-1”) as an index of the word. The feature extraction unit 701 increments a value of the calculated index-numbered element in the “N”-dimensional feature vector. By executing such processing on every word included in a log entry, the feature extraction unit 701 can generate a feature vector indicating an appearance frequency of each word included in the log entry. In this case, a known algorithm may be employed as an algorithm for generating a hash value. Further, as for a number of dimensions (a value of “N”) of the feature vector, a suitable value may be selected considering an effect of a collision caused by different words being allocated to the same index.

As another example, a first feature value may be generated by use of a value indicating a meaning for each field included in a log entry. For example, the feature extraction unit 701 divides one log entry for each field and generates a feature vector having a value indicating information recorded in each field as an element. In this case, for example, an M-dimensional (where M is a natural number) feature vector as illustrated in a part (C) in FIG. 12 (1203 in FIG. 12) is acquired. M herein denotes the total number of fields that may be included in the log entry. As an example, a value indicating a content recorded in the “type” field is set to an element in the feature vector related to the “type” field. Further, a value indicating a content of the “mode” field is set to an element in the feature vector related to the “mode” field. An element in the feature vector related to a field in the log entry to which a numerical value is set (for example “pid” and “value”) may be set with the numerical value. Further, for example, as for a bit field indicating an argument of an API call or the like, an element of the feature vector may be individually allocated for each bit.

The feature extraction unit 701 is not limited to the above and may employ another feature value that can express a content of a log entry. When a content of a log entry is handled as a character string, for example, various feature values used in a common natural language processing technology may be used as such a feature value.

### Second Feature Value

A second feature value extracted by the feature extraction unit 701 will be described below. It is assumed in the description below that, for convenience of description, data recorded in a second log entry are handled as data expressible by a character string or a numerical value. Further, in this case, the feature extraction unit 701 may appropriately convert information recorded in the second log entry into a character string and a numerical value.

As described above, when analyzing a log, an analyst may not only focus on a single log entry but also refer to an overall aspect of the log and related information. For example, it may be considered that an analyst discovers a pattern characteristic of a log (that is, a pattern related to an action of a sample 801) that may not be acquired from one log entry, by checking a plurality of related log entries. It may be considered that, by using information extracted from such a context related to a log as a feature value, a feature value capable of more suitably determining an importance level of a log entry is acquired compared with a case of using a feature value extracted from a single log entry only.

For example, the feature extraction unit 701 may use information indicating a context related to a log that may be generated from information recorded in each second log entry as a second feature value. For example, the feature extraction unit 701 may generate a second feature value by counting pieces of information described in each second log entry or may generate a second feature value by use of a feature value extracted from information described in each second log entry. Specifically, the feature extraction unit 701 may extract feature values as follows as a second feature value indicating a context related to a log.

As an example, the feature extraction unit 701 extracts, for example, information indicating a context of an entire log acquired by executing a sample 801 as a second feature value. It can be said that a second log entry in this case is a log entry satisfying the criterion of being a log entry related to the same sample 801 as a first log entry. For example, by selecting a record including a first log entry and another record with the same sample ID 1000a in a log, the feature extraction unit 701 can specify a record including a second log entry. A specific example of the second feature value in this case will be described below.

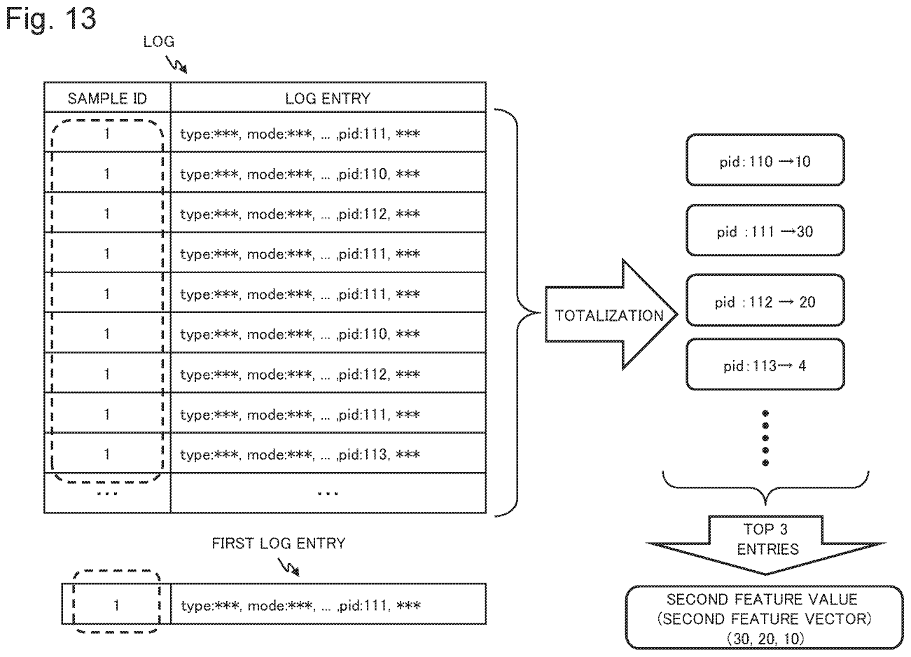

For example, the feature extraction unit 701 may totalize a number of second log entries for each process (for each value in the “pid” field) from all specified second log entries and employ information acquired by arranging the top “x” entries as a second feature value. FIG. 13 is a diagram illustrating a specific example of the second feature value in this case. In this case, with respect to a log entry of each record included in a log, the feature extraction unit 701 totalizes a number of log entries for each value in the “pid” field. The feature extraction unit 701 generates a second feature value from the top N (where N is natural number, and “N=3” in the example in FIG. 13) totalized numbers of entries (30 for “pid: 111,” 20 for “pid: 112,” and 10 for “pid: 110” in the example in FIG. 13). In this case, the second feature value is expressed as a three-dimensional feature vector.

Furthermore, an element of a second feature value may be normalized by dividing the totalized number of log entries by a number of all log entries. In this case, for example, a trend of a process executed in an execution process of a sample 801 (for example, a number of executed processes) may be reflected in a second feature value as a context.

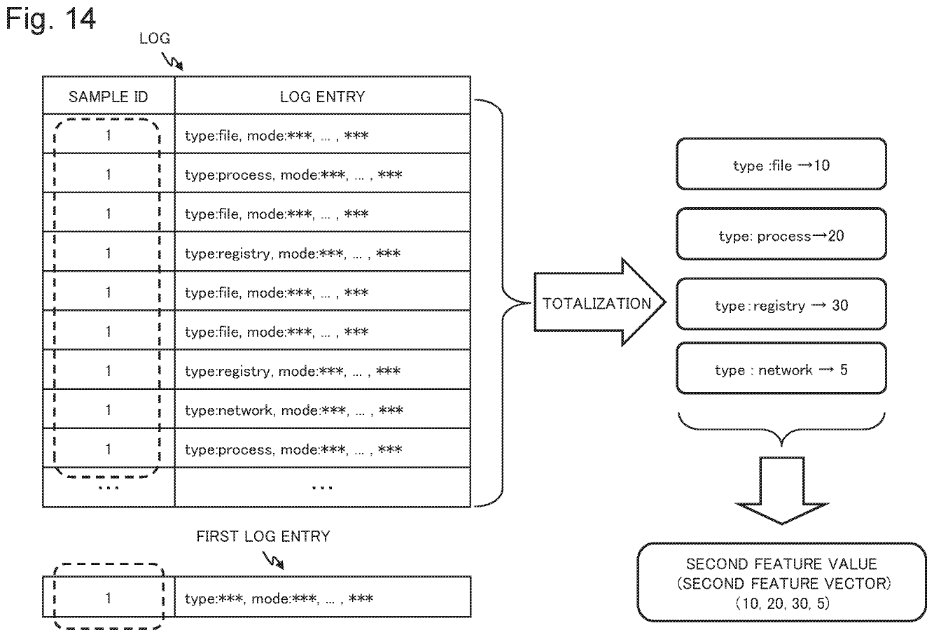

Further, for example, the feature extraction unit 701 may employ information indicating a histogram of a log type calculated from a specified second log entry as a second feature value. FIG. 14 is a diagram illustrating a specific example of the second feature value in this case. In this case, the feature extraction unit 701 generates a histogram by totalizing information recorded in the “type” field for every second log entry included in a log. The feature extraction unit 701 generates a second feature value (four-dimensional feature vector) by use of a frequency counted for each element (for example, “file,” “process,” “registry,” and “network”) of the histogram. In this case, for example, a trend of details of processing executed in an execution process of a sample 801 may be reflected in the second feature value as a context.

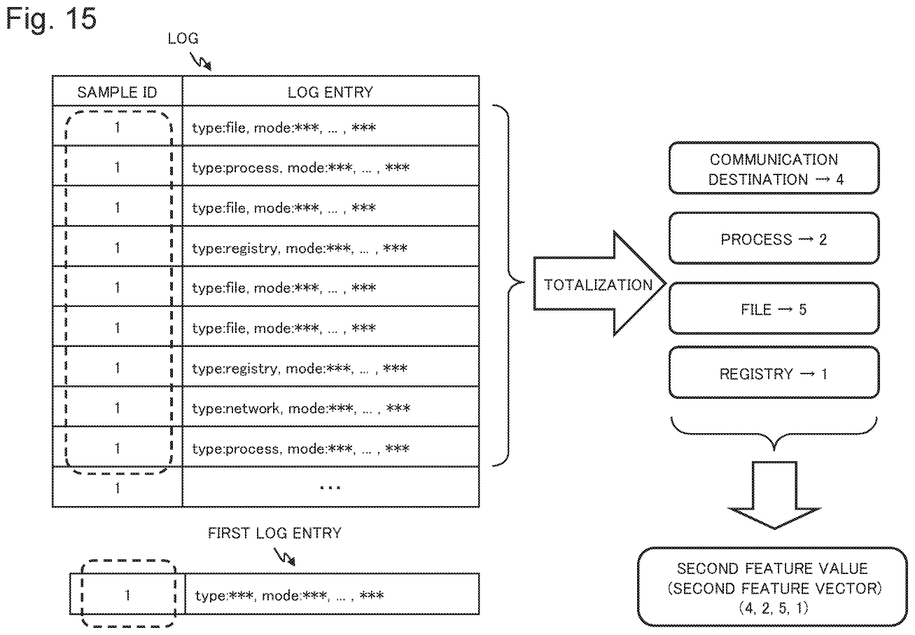

For example, the feature extraction unit 701 may employ, as a second feature value, information such as a number of communication destinations, a number of executed processes, a number of accessed files, and a number of accessed registries that are extracted from every specified second log entry. FIG. 15 is a diagram illustrating a specific example of the second feature value in this case. In this case, for example, the feature extraction unit 701 may select every second log entry in which “network” is recorded in the “type” field from a log and totalize a number of communication destinations from the “host” field or the “ip” field in the log entries.

For example, the feature extraction unit 701 may select every second log entry in which “file” is recorded in the “type” field from a log and totalize a number of accessed files from the “path” field in the log entries.

For example, the feature extraction unit 701 may select every second log entry in which “registry” is recorded in the “type” field from a log and totalize a number of accessed registries from the “key” field in the log entries.

For example, the feature extraction unit 701 may select every second log entry in which “process” is recorded in the “type” field from a log 1000 and totalize a number of executed processes from the “path” field in the log entries.

In the specific example illustrated in FIG. 15, for example, the feature extraction unit 701 generates a second feature value (a four-dimensional feature vector) including a number of communication destinations, a number of executed processes, a number of accessed files, and a number of accessed registries for each log entry type (“type”). In this case, for example, information about a resource for each log type accessed by processing executed in an execution process of a sample 801 may be reflected in the second feature value as a context.

As another example, the feature extraction unit 701 may extract, for example, information indicating a context related to a specific process included in a log acquired by executing a sample 801, as a second feature value.

Specifically, the feature extraction unit 701 selects a first log entry from a log acquired by executing a sample 801 and specifies, as a second log entry, another log entry related to the same process (with the same “pid” field) as the first log entry. In this case, it can be said that the second log entry satisfies the criterion of being a log related to the same process (with the same “pid” field) as a first log entry.

For example, the feature extraction unit 701 in this case may also employ information indicating a histogram of a log type calculated from a specified second log entry as a second feature value, similarly to the above. Further, for example, the feature extraction unit 701 may employ, as a second feature value, information such as a number of communication destinations, a number of executed processes, a number of accessed files, and a number of accessed registries that are extracted from every specified second log entry.

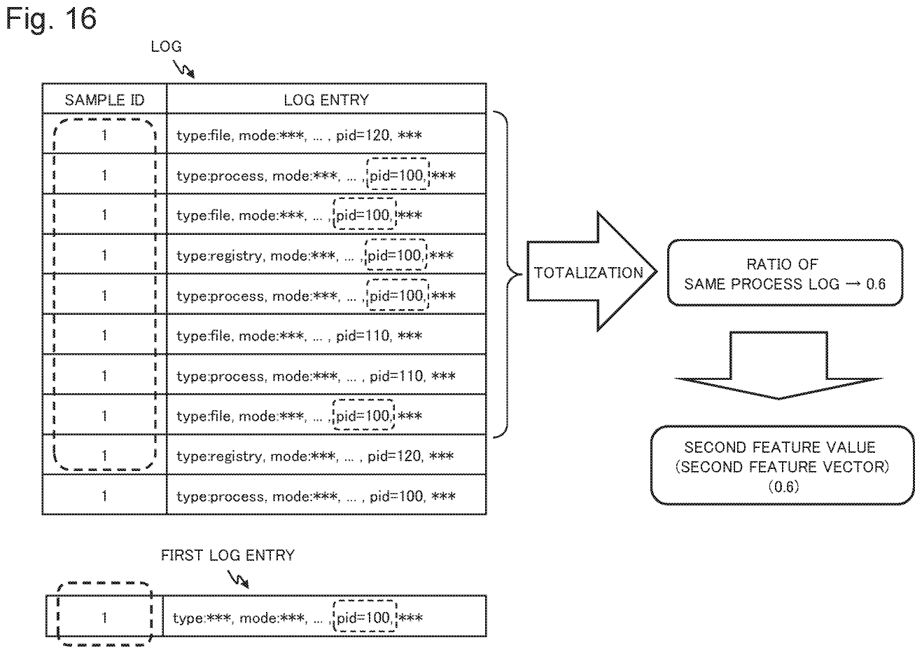

Further, the feature extraction unit 701 may employ, as a second feature value, a ratio of log entries being related to the same process as a first log entry and being included in a log. FIG. 16 is a diagram illustrating a specific example of the second feature value in this case. In this case, the feature extraction unit 701 generates a second feature value (one-dimensional vector) by calculating a ratio of the total number of second log entries having the same “pid” field as a first log entry to the total number of log entries included in a log. In this case, for example, a ratio of executions of a process in an execution process of a sample 801 may be reflected in the second feature value as a context.

As another example, the feature extraction unit 701 may extract, as a second feature value, information indicating, for example, a context acquired from one or more records recorded within a specific range in a time series from a timing at which a record including a first log entry is recorded.

More specifically, the feature extraction unit 701 selects a first log entry from a log acquired by executing a sample 801. For example, the feature extraction unit 701 may select one or more records recorded by a timing of N samples (where N is a natural number) in a time series before a timing at which a record including the selected first log entry is recorded. Further, for example, the feature extraction unit 701 may select one or more records recorded by a timing of M samples (where M is a natural number) in a time series after a timing at which a record including the selected first log entry is recorded. The feature extraction unit 701 may specify, as a second log entry, a log entry included in at least one record out of the records selected as described above. In this case, the second log entry satisfies the criterion of being a log entry recorded within a specific time range in a time series including a timing at which a first log entry is recorded.

For example, the feature extraction unit 701 in this case may also employ information indicating a histogram of a log type calculated from a specified second log entry as a second feature value, similarly to the above. Further, for example, the feature extraction unit 701 may employ, as a second feature value, a ratio of logs related to the same process as a first log entry to all specified second log entries.

As another example, the feature extraction unit 701 may use, for example, information indicating a summary of an action of a sample 801 (summary information) acquired by executing the sample 801, as a second feature value. For example, a case of the sample inspection device 800 being configured by use of a common security product employing a black box technology is assumed. In this case, the sample inspection device 800 can typically provide, as a summary, a result of analyzing an action of a sample 801 other than an action log of the sample 801. Note that such a product is not particularly limited and may be appropriately selected by a person skilled in the art.

A summary provided from a product as described above may typically include information as described below.

(1) A primary determination result of whether or not a sample 801 is malware

(2) A malicious activity executed by a sample 801 (for example, “execution and termination of a specific process,” “a specific API call,” “a specific system call,” “a trial of external communication,” “termination of a specific service,” “a change of a setting related to security,” “access to account information,” “generation of an executable file,” “download of an executable data (including a script),” “file access,” and “registry access”).

Information included in a summary is not limited to the above. For example, a summary may include information indicating a result of the sample inspection device 800 determining whether or not a rule-based activity exists, based on an activity (behavior) of a sample 801.

When a provided summary includes information indicating an activity of a sample 801 as described above, the feature extraction unit 701 may generate a second feature value, based on the information. For example, the feature extraction unit 701 may generate a second feature value indicating, for each malicious activity type, whether or not the sample 801 executes the activity, by use of binary data (for example, 0 or 1). For example, when the number of malicious activity types is M, a second feature value is expressed as an M-dimensional binary vector. When a second feature value is generated from a summary as described above, for example, information being a basis for determining whether or not a sample 801 is malware is included as a feature value. By using such a second feature value, for example, even when existence of a malicious behavior affects an importance level of a log entry, the analysis device 700 can suitably determine an importance level of the log.

Without being limited to the above, for example, when various second feature values (or at least part thereof) being described above and being acquired by counting pieces of information recorded in a second log entry are included in a provided summary, the feature extraction unit 701 may use the feature values as a second feature value. Without being limited to the above, for example, the feature extraction unit 701 may extract a feature value similar to an aforementioned first feature value from each second log entry and generate a second feature value by use of the feature value. In this case, for example, the feature extraction unit 701 may extract a feature value from each second log entry by use of a method similar to the method of extracting a first feature value from an aforementioned first log entry. For example, the feature extraction unit 701 may generate a second feature value by appropriately arranging a feature value extracted from each second log entry. Further, for example, the feature extraction unit 701 may generate a second feature value by calculating statistics (for example, a maximum value, a minimum value, a median, an average, a variance, or a deviation) related to a feature value extracted from each second log entry. Further, the feature extraction unit 701 may generate data (integrated data) acquired by integrating a plurality of second log entries. For example, the integrated data may be data acquired by arranging every piece of information recorded in each second log entry. The feature extraction unit 701 may extract a feature value similar to a first feature value described above from the integrated data and use the extracted feature value as a second feature value.

The feature extraction unit 701 generates feature information related to a first log entry by use of a first feature value extracted from the first log entry and a second feature value extracted from one or more second log entries, similarly to the feature extraction unit 101 according to the aforementioned first example embodiment.

### Analysis Model

An analysis model generated by the analysis model generation unit 702 will be described below.

As described above, an analysis model is a model capable of determining an importance level related to a log entry by giving feature information related to the log entry as an input. For example, a model used in machine learning or pattern recognition may be used as such a model. For example, an SVM, a multilayer NN, gradient boosted trees, and random forests may be employed as specific examples of a model employable as an analysis model. Learning of an analysis model and evaluation of an importance level using an analysis model when the aforementioned models are employed will be described below.

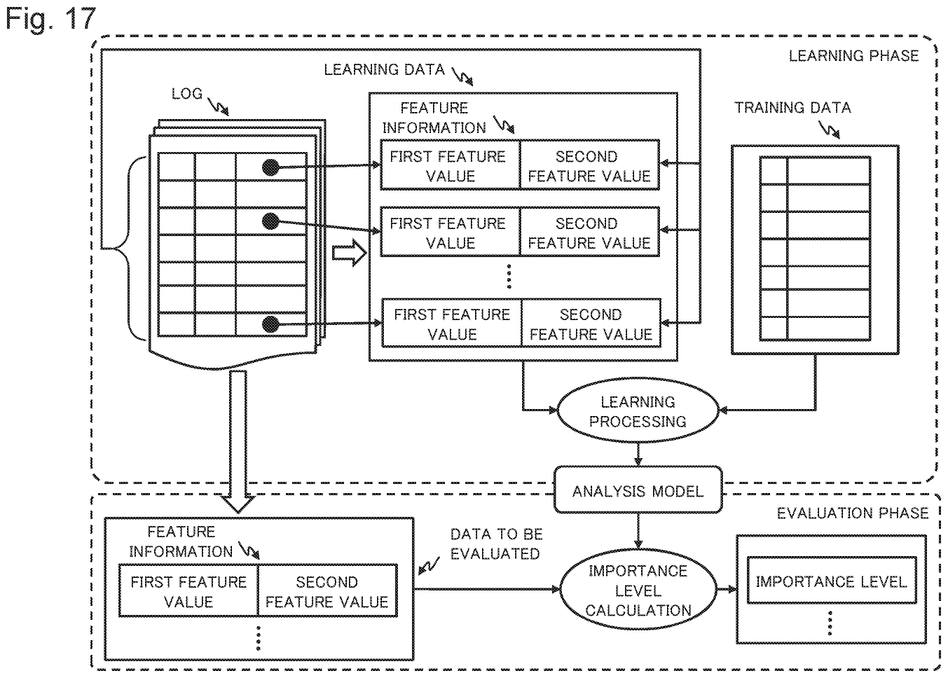

FIG. 17 is a diagram illustrating an outline of learning of an analysis model and importance level evaluation using an analysis model. The analysis model generation unit 702 executes learning processing related to an analysis model by use of learning data including feature information being related to a first log entry and being extracted by the feature extraction unit 701, and training data provided from the training data providing unit 706 (a “learning phase” in FIG. 17).

For example, when an SVM is used as an analysis model, the analysis model generation unit 702 learns a discriminant function (discriminant plane) of the SVM by use of learning data and training data. The SVM may be applied to regression (support vector regression [SVR]). In this case, a parameter of the discriminant function is learned in such a way that a permissible error between a value calculated by inputting feature information given as learning data to the discriminant function and a value given as training data is minimized. A suitable method including a known technology may be employed as a learning method of a parameter in the SVR.

For example, when a multilayer NN is used as an analysis model, the analysis model generation unit 702 learns a coupling parameter of a node (neuron) constituting the multilayer NN by use of learning data and training data. A specific network configuration (such as a number of layers and a number of nodes in each layer) of the multilayer NN may be appropriately defined. Further, for example, an input layer of the multilayer NN may be configured with the same number of input nodes as a number of elements (number of dimensions) of a vector representing feature information. In this case, each element of the vector representing the feature information is respectively input to each node in the input layer. Further, an output layer of the multilayer NN may be configured with one output node (an output node for regression). In this case, for example, a normalized linear function or the like may be set to the node in the output layer as an activation function. A suitable method including a known technology may be employed as a learning method of the multilayer NN.

For example, when gradient boosted trees or random forests is used as an analysis model, the analysis model generation unit 702 learns one or more decision trees constituting the data, by use of learning data and training data. A number of decision trees and a structure of each decision tree may be appropriately selected. A suitable method including a known technology may be employed as a learning method of gradient boosted trees and random forests.

The importance level calculation unit 703 calculates an importance level related to a log entry to be evaluated, by use of an analysis model generated by the analysis model generation unit 702. More specifically, by inputting feature information generated for a log entry by the feature extraction unit 701 to an analysis model, the importance level calculation unit 703 calculates an importance level related to the feature information (an evaluation phase in FIG. 17).

For example, when an SVM is used as an analysis model, a value calculated by inputting feature information to a discriminant function of the SVM may be used as a value indicating an importance level related to the feature information. For example, when a multilayer NN is used as an analysis model, a value acquired from an output layer by inputting each element of feature information to an input layer of the multilayer NN may be used as a value indicating an importance level related to the feature information. For example, when gradient boosted trees or random forests is used as an analysis model, the weighted sum or the average of outputs of decision trees when feature information is given as an input may be used as a value indicating an importance level related to the feature information.

Furthermore, a number of analysis models according to the present example embodiment is not limited to one, and a plurality of analysis models may be used. More specifically, the analysis model generation unit 702 may generate a plurality of analysis models, based on a content and a type of a log entry. For example, when other information (field) included in each log entry differs for each log type (information in the “type” field), the analysis model generation unit 702 may generate an analysis model for each log type. As an example, a case of a log type including four types (for example, a value of the “type” field takes “file,” “process,” “registry,” and “network”) is assumed. In this case, the analysis model generation unit 702 generates four analysis models (an analysis model related to a log entry having “file” as a value of the “type” field, an analysis model related to a log entry having “process” as the value, an analysis model related to a log entry having “registry” as the value, and an analysis model related to a log entry having “network” as the value) for each log entry type. In this case, the analysis model generation unit 702 learns the analysis model for each log type by use of a log entry for each log type included in learning data. Further, based on a log type recorded in a log entry in a record to be evaluated, the importance level calculation unit calculates an importance level by use of an analysis model for the log type.

### Display of Log

Display of a log by the display control unit 704 will be described below. As described above, the display control unit 704 displays a user interface allowing control of display of a log related to a sample 801, based on an importance level calculated in the importance level calculation unit 703. More specifically, the display control unit 704 may generate display data used for display of such a user interface.

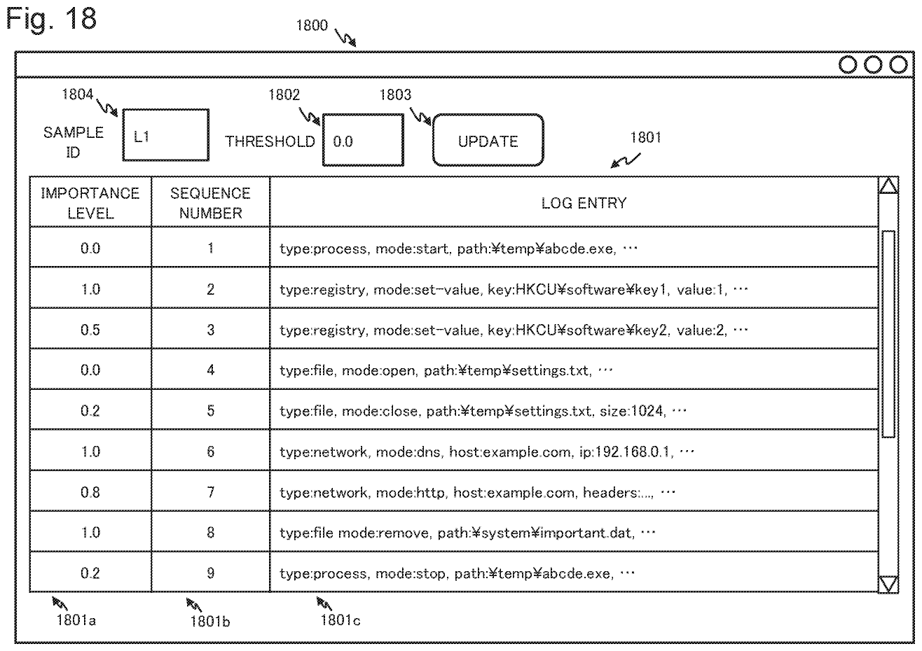

As an example, the display control unit 704 may generate display data for displaying a user interface 1800 as illustrated in FIG. 18.

The user interface 1800 illustrated in FIG. 18 constitutes at least part of a graphical user interface (GUI) displayed to a user of the analysis device 700.

For example, the user interface 1800 may include a log entry display field (1801 in FIG. 18), a threshold setting field (1802 in FIG. 18), an update button (1803 in FIG. 18), and a sample setting field (1804 in FIG. 18).

The log entry display field 1801 is a field allowing display of a log entry in a record included in a log provided by the action log providing unit 705. The log entry display field 1801 displays a log when a sample 801 specified by a sample ID set in the sample setting field 1804 (to be described later) is executed. Further, the display control unit 704 may acquire a log related to a sample specified by a sample ID from the action log providing unit 705, at a timing when the sample ID set to the sample setting field 1804 is changed.

The log entry display field 1801 displays a log entry in a log provided from the action log providing unit 705, the log entry having an importance level greater than or equal to a threshold set in the threshold setting field 1802 (to be described later). In other words, an importance level calculated in the importance level calculation unit 703 with respect to a log entry displayed in the log entry display field 1801 is greater than or equal to the threshold set in the threshold setting field 1802 (to be described later).

When a log provided from the action log providing unit 705 includes a log entry assigned with a training score (that is, when a log entry used as learning data is included), an importance level 1801a may display the training score.

The threshold setting field 1802 and the update button 1803 are control elements (controls) allowing setting (adjustment) of an importance level of a log entry displayed in the log entry display field. The threshold setting field 1802 is an input field allowing a user operating the user interface 1800 to set a threshold. As an example, the threshold setting field 1802 may be provided by use of a text box or a numerical value input control but is not limited thereto. The update button 1803 is a control element for updating a display content of the log entry display field 1801, based on a threshold set to the threshold setting field 1802. For example, a display content of the log entry display field 1801 is updated in such a way that, by the update button 1803 being depressed by a user, a log entry having a threshold set to the threshold setting field 1802 or greater is displayed.

Specifically, for example, an event indicating that a user depresses the update button 1803 and a threshold set to the threshold setting field 1802 at the timing are conveyed to the display control unit 704 through the user interface 1800. The display control unit 704 specifies a log entry having an importance level greater than or equal to the notified threshold and generates display data in such a way as to display the log entry. Transmission and reception of an event or the like and an update of the display through the GUI may be provided by use of a known technology.

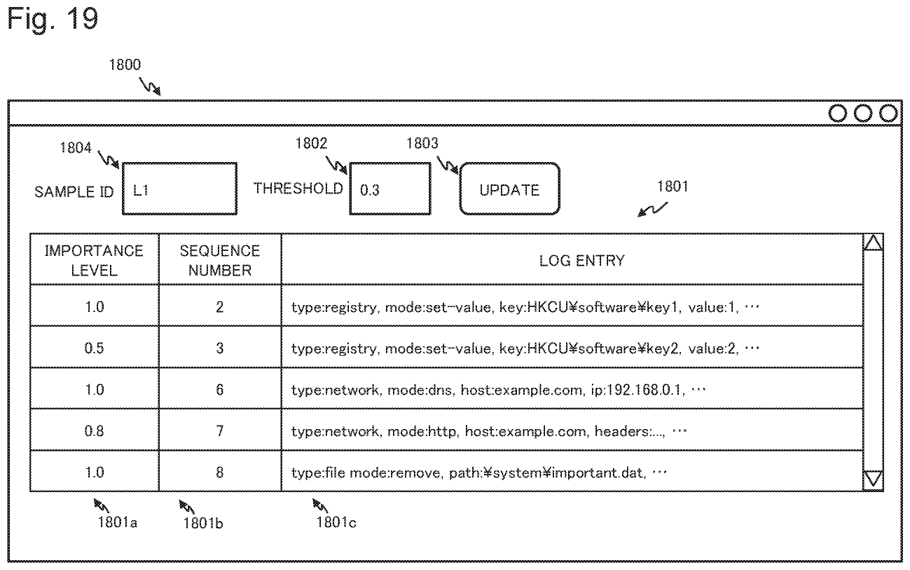

For example, it is assumed in the user interface illustrated in FIG. 18 that “0.3” is set to the threshold setting field 1802, and the update button 1803 is depressed. In this case, for example, the display control unit 704 generates (updates) display data in such a way that a user interface 1800 illustrated in FIG. 19 is displayed. In FIG. 19, the log entry display field 1801 only displays log entries having an importance level greater than or equal to “0.3.” In other words, the display control unit 704 controls a display content in such a way that a log entry having an importance level less than a threshold is not displayed.

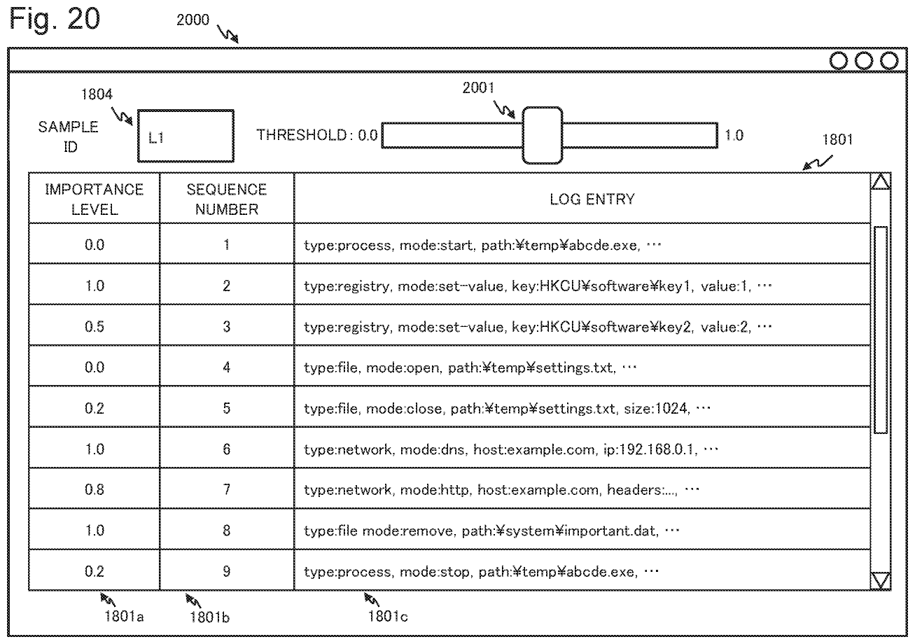

As another example, the display control unit 704 may generate display data for displaying a user interface 2000 as illustrated in FIG. 20. The user interface 2000 includes a slider 2001 in place of the threshold setting field 1802 and the update button 1803 in the user interface 1800. The other elements constituting the user interface 2000 may be similar to those in the user interface 1800.

The slider 2001 is a control element allowing setting (adjustment) of an importance level of a log entry displayed in the log entry display field. For example, by operating the slider 2001, a threshold is updated based on a position of the slider. For example, the display control unit 704 specifies a log entry having an importance level greater than or equal to the threshold indicated by the position of the slider and generates display data for displaying the log entry.

As yet another example, the display control unit 704 may change (adjust) a display method of each log entry, depending on an importance level of each log entry. In the specific examples illustrated in FIG. 18 to FIG. 20, the display control unit 704 generates a user interface for not displaying a log entry having an importance level less than a threshold. Without being limited to the above, for example, the display control unit 704 may highlight a log entry having an importance level greater than or equal to a threshold and also restrainedly (inconspicuously) display a log entry having an importance level less than the threshold. A method of highlighting each log entry by the display control unit 704 and a method of restrainedly displaying each log entry are not particularly limited and may be appropriately selected. For example, the display control unit 704 may generate a user interface highlighting a log entry having an importance level greater than or equal to a threshold and also graying out a log entry having an importance level less than the threshold. Further, for example, the display control unit 704 may generate a user interface displaying a log entry having an importance level greater than or equal to a threshold in a larger size than a log entry having an importance level less than the threshold.

### Operation of Analysis Device 700

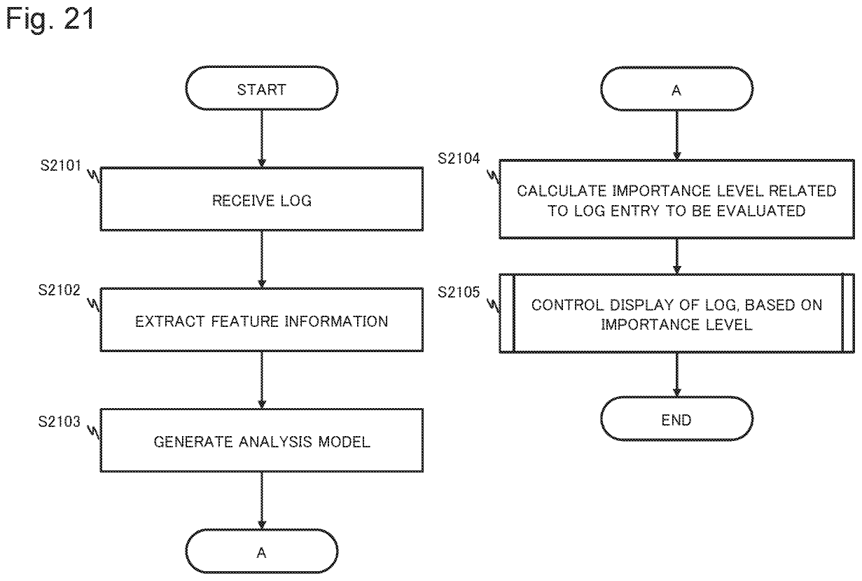

An operation of the analysis device 700 configured as described above will be described. FIG. 21 is a flowchart illustrating an operation example of the analysis device 700.

The analysis device 700 receives a log recorded when a sample 801 is executed in the sample inspection device 800 (Step S2101). When the analysis device 700 includes the action log providing unit 705, the action log providing unit 705 may keep (store) the log provided from the sample inspection device 800.

With respect to a log entry in a record used as learning data in the log provided from the sample inspection device 800, the analysis device 700 generates feature information indicating a feature of the log entry (Step S2102).

Specifically, the feature extraction unit 701 extracts a first feature value from a log entry (first log entry) in one record. Further, the feature extraction unit extracts a second feature value from log entries (second log entries) in one or more records included in a log. By use of the first feature value and the second feature value, the feature extraction unit 701 generates feature information related to the log entry in the one record. A specific example of a method of extracting a first feature value and a second feature value is as described above.

For example, the feature extraction unit 701 may specify a record including a log entry assigned with a training score as a record used as learning data. The feature extraction unit 701 may further generate feature information for a log entry in a record to be evaluated included in a log. Note that a record used as learning data and a record used as data to be evaluated may be included in the same log or in different logs. The feature extraction unit 701 may provide the analysis model generation unit 702 with learning data including feature information generated for each log entry.

The analysis device 700 generates an analysis model by use of the learning data generated in Step S2102 and training data (Step S2103).

Specifically, the analysis model generation unit 702 executes learning processing of an analysis model by use of learning data generated by the feature extraction unit 701 and training data stored in the training data providing unit 706. As described above, the analysis model generation unit 702 may generate a plurality of analysis models depending on a content and the like of a log entry. Specific examples of an analysis model and learning processing thereof are as described above.

Through the processing in Step S2101 to Step S2103, the analysis device 700 can generate an analysis model capable of determining an importance level of a log entry included in a record.

When generating an analysis model in Step S2103, the analysis device 700 may end the processing or may execute evaluation and display of the log (processing in and after Step S2104).

An operation related to evaluation and display of a log by the analysis device 700 will be described below.

By use of the analysis model generated in Step S2101 to Step S2103, the analysis device 700 calculates an importance level of a log entry in a record to be evaluated (Step S2104).

Specifically, the feature extraction unit 701 generates feature information related to a log entry in a record to be evaluated. The record to be evaluated may be all records included in a log or a record not used as learning data.

The importance level calculation unit 703 inputs the feature information being related to the log entry in the record to be evaluated and being generated in the feature extraction unit 701 to the analysis model, and calculates an importance level. The importance level calculation unit 703 provides the calculated importance level for the display control unit 704.

Furthermore, when a plurality of analysis models are generated based on a content of a log, the analysis device 700 may select a suitable analysis model, based on a content of the log entry in the record to be evaluated and calculate an importance level.

Based on the importance level being related to the log entry to be evaluated and being calculated in Step S2104, the analysis device 700 controls display of a log including the log entry (more specifically, a log in which the record including the log entry is recorded) (Step S2105).

Specifically, for example, the display control unit 704 acquires a log from the action log providing unit 705 and receives, from the importance level calculation unit 703, an importance level calculated for the log entry in the record to be evaluated out of records recorded in the log.

The display control unit 704 displays a user interface allowing control of display of a log related to the sample 801, based on the importance level calculated in the importance level calculation unit 703. A specific example of such a user interface is as described above.

Through the processing in Step S2104 and Step S2105, the analysis device 700 can control a method of displaying each log entry included in a record, based on an importance level of each log entry.

For example, the analysis device 700 according to the present example embodiment configured as described above provides a practical effect as follows.

The analysis device 700 according to the present example embodiment enables suitable determination of importance of a log. Specifically, from a log entry used as learning data, the analysis device 700 generates feature information of the log entry and learns an analysis model by use of learning data including the generated feature information and training data including importance level information assigned to a log entry. By using an analysis model learned as described above, for example, the analysis device 700 can determine an importance level of each log entry included in a log.

Further, the analysis device 700 can extract a second feature value indicating a context of a log, from one or more second log entries. Specifically, for example, the analysis device 700 extracts, as a second feature value, an overall feature of a log acquired in an execution process of a sample 801, a feature of a log related to a specific process executed in an execution process of a sample 801, a feature related to a log entry recorded adjacently to a log entry, and the like. Consequently, the analysis device 700 can include information indicating a context of a log into feature information generated from a log entry.

Further, by use of a first feature value indicating a feature of one log entry and a second feature value indicating a context of a log, the analysis device 700 generates feature information related to the one log entry, similarly to the aforementioned first example embodiment. Consequently, the analysis device 700 can reflect the context of the log in the feature information related to the one log entry. By learning an analysis model by use of such feature information, the analysis device 700 can generate an analysis model capable of more suitably determining importance of a log entry.

Further, based on an importance level of a log entry included in a log, the analysis device 700 can control a display mode of the log entry. Specifically, the analysis device 700 can calculate an importance level related to a log entry to be evaluated, by use of a generated analysis model, and control a display mode of the log entry, based on an importance level thereof. For example, the analysis device 700 may display a log entry having an importance level greater than or equal to an importance level specified by a user and suppress a log entry having an importance level less than the importance level specified by the user. Consequently, the analysis device 700 can present a log entry to be focused on, based on the importance level specified by the user, and therefore can improve efficiency of analysis work by the user.

Further, the analysis device 700 can generate a plurality of analysis models depending on a content or the like of a log. For example, a case of a content of a field recorded in a log entry and a number of fields varying by log type is assumed. In this case, when a feature value (feature vector) allowing expression of every log type is generated, a feature value of a high order (with a large number of elements) or a sparse feature value may be generated. Learning processing using such a feature value may require a relatively large storage area (memory area). Further, when an analysis model is learned by use of such a feature value, for example, a feature for each log type may be diluted. On the other hand, for example, when a different analysis model is generated for each log type, a feature value of an unnecessarily high order does not need to be generated, and therefore processing efficiency can be improved. Further, in this case, it may be considered that an analysis model reflecting a unique feature for each log type is generated. By using such an analysis model, an importance level of each entry can be more suitably calculated.

### Modified Example 1 of Second Example Embodiment

A first modified example of the second example embodiment (described as a “modified example 1”) will be described below. A configuration similar to that according to each of the aforementioned example embodiments is hereinafter given a similar reference sign, and detailed description thereof is omitted.

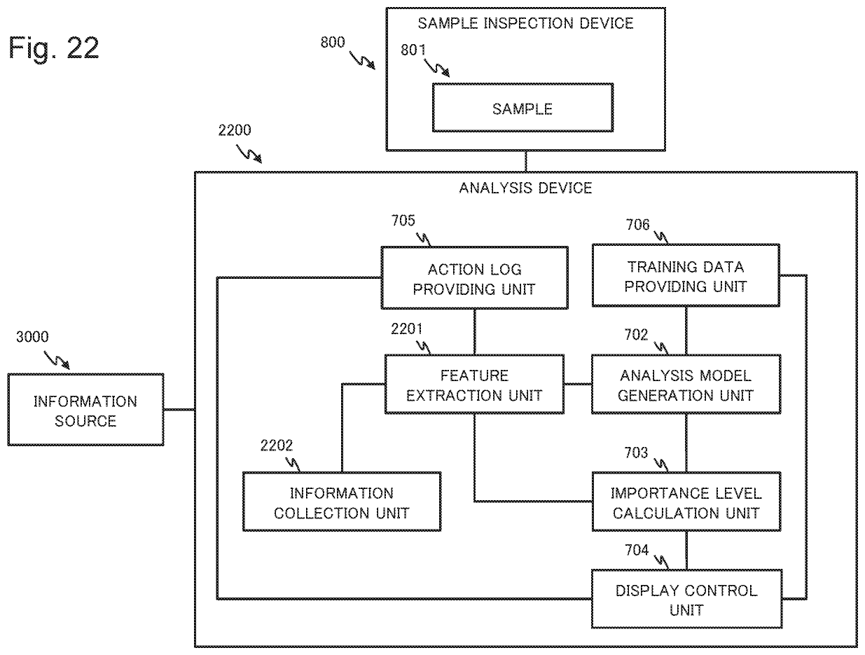

FIG. 22 is a block diagram conceptually illustrating a functional configuration of an analysis device 2200 in this modified example 1. The analysis device 2200 in this modified example 1 further includes an information collection unit 2202 compared with the analysis device 700 according to the second example embodiment. Further, a function of a feature extraction unit 2201 in the analysis device 2200 is extended from that of the feature extraction unit 701 in the analysis device 700 according to the second example embodiment. Such a difference will be mainly described below.

The information collection unit 2202 (information collection means) acquires information related to a log acquired by executing a sample 801, or the like from an information source 3000 existing outside the analysis device 2200. Specifically, the information collection unit 2202 may acquire information related to a content recorded in a first log entry from the external information source 3000. Information acquired by the information collection unit 2202 from the external information source 3000 is hereinafter described as external context information.

In this modified example 1, a type of the information source 3000 is not particularly limited and may be appropriately selected. For example, the information source 3000 may include an information providing service provided by vendors of various security products or the like. Further, the information source 3000 may include a database accumulating various types of security information. The information source 3000 may include sites from which various organizations (for example, various computer security incident response teams [CSIRT]) coping with security events (incidents) send out information. Further, the information source 3000 may include an information retrieval service on the Internet and a social networking service that are common today. Further, the information source 3000 may include services providing network-related information, such as a domain name service (DNS) and WHOIS.

For example, in response to a request from the feature extraction unit 2201 (to be described later), the information collection unit 2202 selects an information source 3000 providing suitable information related to a content recorded in a first log entry and acquires external context information. A specific method of acquiring an external context by the information collection unit 2202 may be suitably selected based on a configuration, a specification, and the like of the information source 3000. Specifically, for example, the information collection unit 2202 may acquire external context information from the information source 3000 in accordance with a specific communication protocol. For example, the information collection unit 2202 may transmit a specific query to the information source 3000 and receive a response to the query. The information collection unit 2202 may acquire external context information by use of a specific API provided by the information source 3000.

The information collection unit 2202 provides the external context information acquired from the information source 3000 for the feature extraction unit 2201.

The feature extraction unit 2201 in this modified example 1 has a function similar to that of the feature extraction unit 701 in the analysis device 700 according to the second example embodiment. The feature extraction unit 2201 is configured to further extract a feature value from external context information. A feature value extracted from external context information may be hereinafter described as a “third feature value.”

For example, the feature extraction unit 2201 may request the information collection unit 2202 to acquire external context information. At this time, the feature extraction unit 2201 may provide a content recorded in a first log entry for the information collection unit 2202.

The feature extraction unit 2201 extracts a third feature value from external context information collected by the information collection unit 2202 and generates feature information related to the first log entry. Specifically, the feature extraction unit 2201 may generate feature information related to a first log entry by use of a first feature value and a third feature value or may generate feature information related to a first log entry by use of a first feature value, a second feature value, and a third feature value.

The other components in the analysis device 2200 in this modified example 1 may be considered roughly similar to the components in the analysis device 700 according to the aforementioned second example embodiment.

Specifically, an analysis model generation unit 702 generates an analysis model by use of learning data provided from the feature extraction unit 2201 and training data stored in a training data providing unit 706. An importance level calculation unit 703 is configured to calculate an importance level related to a log entry by use of an analysis model generated by the analysis model generation unit 702 and provide the importance level the for a display control unit 704, similarly to the aforementioned second example embodiment.

The display control unit 704 is configured to generate an interface allowing control of display of each log entry, based on an importance level of the log entry calculated by the importance level calculation unit 703, similarly to the aforementioned second example embodiment.

An action log providing unit 705 keeps (stores) a log recorded with execution of a sample 801, similarly to the aforementioned second example embodiment, and the training data providing unit 706 keeps (stores) training data including a training score assigned to a log entry used as learning data.

### External Context Information and Third Feature Value

External context information and a third feature value extracted from an external context will be described below. As described above, the information collection unit 2202 acquires external context information related to a content of a first log entry from an information source 3000. As an example, the information collection unit 2202 selects a suitable information source 3000 depending on a log type (information in the “type” field) of the first log entry and acquires external context information. In this case, for example, the information collection unit 2202 may previously keep (store) a table or the like associating a log type of a first log entry with an information source 3000 from which external context information related to the log type can be acquired.

As an example, a case of “file” being set to the “type” field being a log type of a first log entry is assumed. In this case, for example, a specific file can be specified from the “path” field in the first log context.

For example, the information collection unit 2202 may acquire information allowing determination of whether or not the specified file is detected by an antivirus product, from the information source 3000, and provide the information for the feature extraction unit 2201 as external context information. In this case, for example, the feature extraction unit 2201 may include, into a third feature value, a value (for example, a Boolean value) indicating whether or not the file specified by the “path” field in the first log entry is detected by an antivirus product.

Further, for example, the information collection unit 2202 may acquire a number of times the file is acquired (for example, a number of users downloading the file) from the information source 3000 and provide the number for the feature extraction unit 2201 as external context information. In this case, for example, the feature extraction unit 2201 may include, into a third feature value, a value indicating the number of times the file specified by the “path” field in the first log entry is downloaded.

Further, for example, the information collection unit 2202 may acquire information indicating a confidence level of the file from an information source 3000 and provide the confidence level for the feature extraction unit 2201 as external context information. In this case, for example, the feature extraction unit 2201 may include, into a third feature value, a value indicating the confidence level of the file specified by the “path” field in the first log entry. Further, a confidence level of a file may be appropriately set in an information source 3000, based on details of processing executed by the file, a provider of the file, existence of an incident related to the file, and the like.

In the case described above, for example, vendors of various security products or the like, and sites or the like from which various organizations coping with security events send out information may be included as an information source 3000. For example, the information collection unit 2202 can collect external context information as described above by searching the information source 3000 for a name of the file (file name), a content or data including a hash value of the file, or the like. In this case, for example, it may be considered that the information collection unit 2202 acquires information indicating a reputation related to security of a file as external context information.

As another example, a case of “registry” being set to the “type” field being a log type of a first log entry is assumed. In this case, for example, a specific registry key can be specified from the “key” field in the first log context.

For example, the information collection unit 2202 may acquire information allowing determination of whether or not known malware accessing the specified registry key exists from an information source 3000 and provide the determination for the feature extraction unit 2201 as external context information. Furthermore, when known malware accessing the specified registry key exists, the information collection unit 2202 may acquire a name, a classification name, a hash value, and the like of the malware and provide the information for the feature extraction unit 2201 as external context information.

In this case, for example, the feature extraction unit 2201 may include, into a third feature value, a value (for example, a Boolean value) indicating whether or not known malware accessing the registry specified by the “key” field in the first log entry exists. Further, when known malware accessing the specified registry key exists, the feature extraction unit 2201 may include a name, a classification name, a hash value, and the like of the malware into a third feature value. At this time, the name, the classification name, and the like of the malware may be appropriately converted into a string representation or a numeric representation. In this case, for example, it may be considered that the information collection unit 2202 acquires information indicating a reputation related to security of a registry key as external context information.

As yet another example, a case of “network” being set to the “type” field being a log type of a first log entry is assumed. In this case, for example, a communication destination can be specified from the “host” field, the “ip” field, the “url” field, and the like in the first log context.

For example, the information collection unit 2202 may acquire information indicating an evaluation related to the specified communication destination from an information source 3000 and provide the information for the feature extraction unit 2201 as external context information. For example, information indicating an evaluation related to a communication destination may include an evaluation related to a host of the communication destination itself, an evaluation related to a domain to which the communication destination belongs, an evaluation related to a URL, and the like. For example, such an evaluation may include a number of users accessing the host, a number of users accessing the domain, a number of users accessing the URL, and the like. Further, such an evaluation may include whether or not the host, the domain, the URL, or the like is registered in a known blacklist, and the like. A blacklist is a list in which a communication destination or the like having a problem from a security viewpoint is registered. In this case, for example, the feature extraction unit 2201 may include information indicating an evaluation related to the specified communication destination into a third feature value. Specifically, for example, the feature extraction unit 2201 may include, into a third feature value, a value indicating a number of users accessing the communication destination, a value (for example, a Boolean value) indicating whether or not the communication destination is registered in a blacklist, and the like. In this case, for example, it may be considered that the information collection unit 2202 acquires information indicating a reputation related to security of a communication destination as external context information.

Without being limited to the above, for example, the information collection unit 2202 may acquire an area (such as a country or a region) where a specified communication destination exists from an information source 3000 and provide the area for the feature extraction unit 2201 as external context information. For example, the information collection unit 2202 may specify a country allocated with an IP address set in the “ip” field and provide information indicating the country for the feature extraction unit 2201. In this case, for example, the feature extraction unit 2201 may include information indicating the area (such as a country or a region) where the specified communication destination exists into a third feature value. At this time, a name of the area where the communication destination exists may be appropriately converted into a string representation or a numeric representation.

Without being limited to the above, for example, the information collection unit 2202 may acquire an owner of a specified communication destination (more specifically, an owner of an IP address of the communication destination) from an information source 3000 and provide the owner for the feature extraction unit 2201 as external context information. For example, from an IP address set to the “ip” field, the information collection unit 2202 may acquire information about an owner of the IP address by use of the WHOIS protocol which is common today or the like. In this case, for example, the feature extraction unit 2201 may include at least part of information indicating the owner of the specified communication destination into a third feature value. At this time, the information indicating the owner of the communication destination may be appropriately converted into a string representation or a numeric representation.

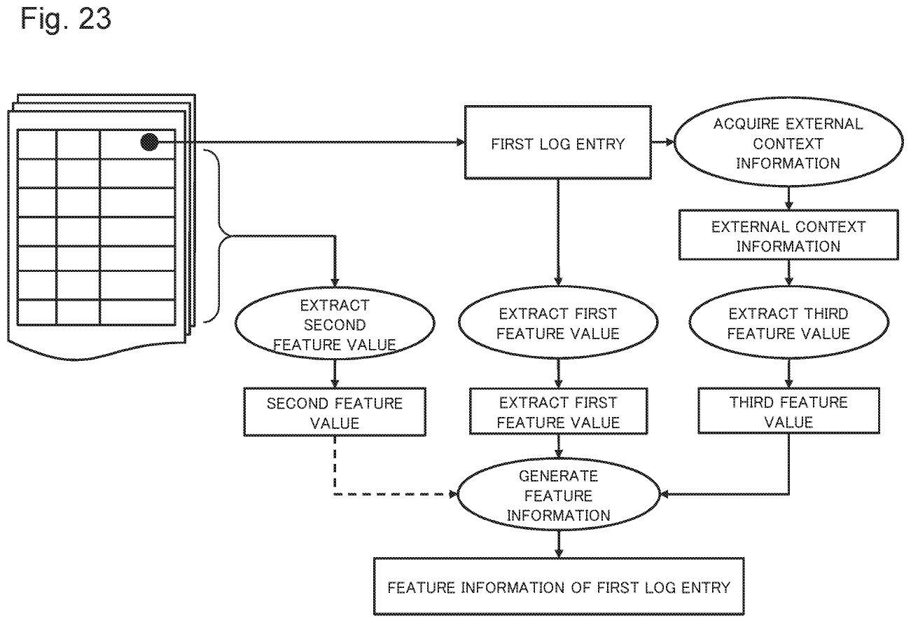

FIG. 23 is a diagram schematically illustrating a process of acquiring an external context by the information collection unit 2202 and extracting a third feature value by the feature extraction unit 2201. As illustrated in FIG. 23, for example, the feature extraction unit 2201 may generate a feature vector representing feature information of a first log entry by appropriately arranging elements of a feature vector representing a first feature value and elements of a feature vector representing a third feature value. Further, for example, the feature extraction unit 2201 may generate a feature vector representing feature information of a first log entry by appropriately arranging elements of a feature vector representing a first feature value, elements of a feature vector representing a second feature value, and elements of a feature vector representing a third feature value.

### Operation

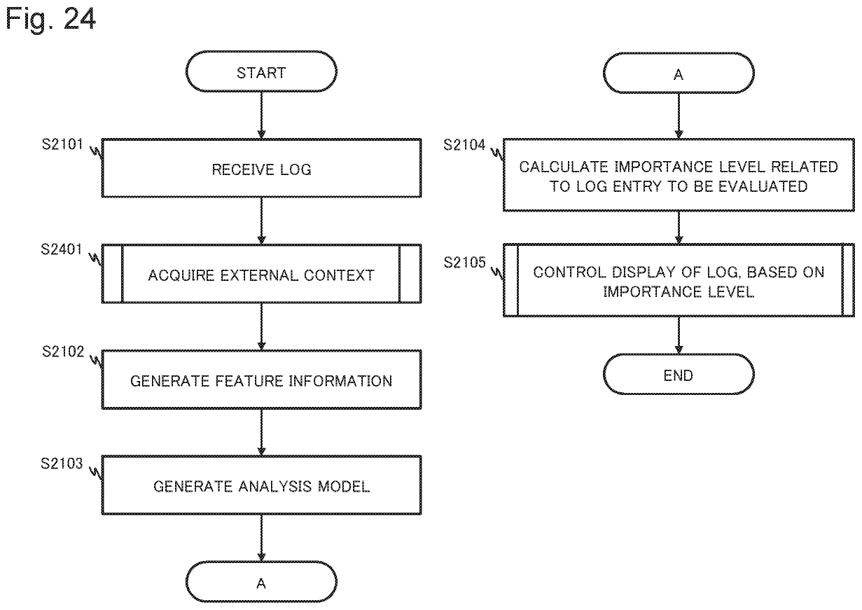

An operation of the analysis device 2200 will be described below. FIG. 24 is a flowchart illustrating an operation example of the analysis device 2200. Out of steps in the flowchart illustrated in FIG. 24, processing similar to the operation of the analysis device 700 according to the second example embodiment is given the same reference sign as that in the flowchart illustrated in FIG. 21, and detailed description thereof is omitted.

The analysis device 2200 receives a log recorded in a process of executing a sample 801 from the sample inspection device 800, similarly to the aforementioned second example embodiment (Step S2101).

The analysis device 2200 acquires external context information related to a log entry (first log entry) in a record used as learning data in the received log (Step S2401).

Specifically, the feature extraction unit 2201 requests the information collection unit 2202 to acquire external context information related to a content of the first log entry. The information collection unit 2202 selects an information source 3000, based on the content of the first log entry and acquires information based on the content of the first log entry from the information source 3000. The information collection unit 2202 provides the acquired information for the feature extraction unit 2201 as external context information. A specific example of external context information is as described above.

Processing in Step S2102 to Step S2104 may be considered roughly similar to that according to the aforementioned second example embodiment. Specifically, the analysis device 700 generates feature information related to the first log entry by use of a first feature value extracted from the first log entry and a third feature value extracted from the external context information in Step S2102. At this time, the analysis device 700 may generate feature information related to the first log entry by use of a second feature value indicating a context of a log, in addition to the first and third feature values. The analysis device 700 generates an analysis model by use of learning data including the feature information generated in Step S2103 and training data (Step S2103), calculates an importance level related to a log entry to be evaluated (Step S2104), and controls display of a log entry, based on the importance level (Step S2105).

For example, the analysis device 700 according to the present example embodiment as configured above provides a practical effect as follows.

The analysis device 2200 configured as described above can include external context information into feature information of a log entry used as learning data. Today, various types of information related to various security events are provided by vendors of various security products and the like, and various organizations coping with security events. For example, it may be considered that, by checking such information, an analyst can more suitably determine importance of a log entry. On the other hand, the analysis device 2200 in this modified example 1 generates feature information including a feature value extracted from one log entry and a feature value extracted from an external context. In other words, it may be considered that, by using feature information including external context information, the analysis device 2200 can generate an analysis model capable of more suitably determining importance of a log entry. From the above, the analysis device 2200 in this modified example 1 can more suitably determine importance of a log.

### Modified Example 2 of Second Example Embodiment

A second modified example of the second example embodiment (described as a “modified example 2”) will be described below. A configuration similar to that according to each of the aforementioned example embodiments and modified example is hereinafter given a similar reference sign, and detailed description thereof is omitted.

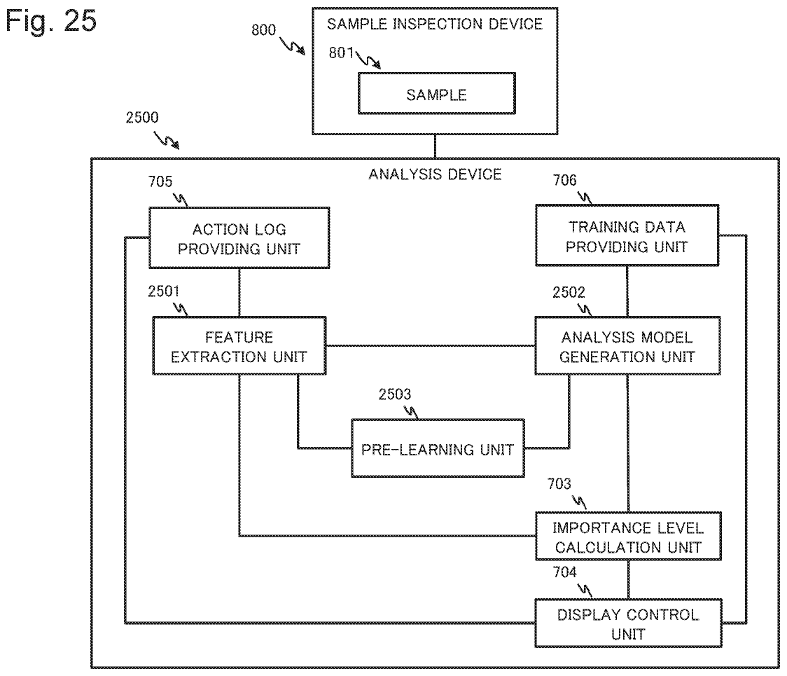

FIG. 25 is a block diagram conceptually illustrating a functional configuration of an analysis device 2500 in this modified example 2. The analysis device 2500 in this modified example 2 further includes a pre-learning unit 2503 compared with the analysis device 700 according to the second example embodiment. Further, a function of a feature extraction unit 2501 in the analysis device 2500 is extended from that of the feature extraction unit 701 in the analysis device 700 according to the second example embodiment. Further, a function of an analysis model generation unit 2502 in the analysis device 2500 is extended from that of the analysis model generation unit 702 in the analysis device 700 according to the second example embodiment. Such a difference will be mainly described below. Further, it is assumed in this modified example that an analysis model generated by the analysis model generation unit 702 is a multilayer NN.

The feature extraction unit 2501 generates feature information related to a log entry in a record included in a log provided from the sample inspection device 800. For example, a specific method of generating feature information may be similar to that according to the aforementioned second example embodiment and the modified example 1 thereof.

The feature extraction unit 2501 in this modified example 2 is configured to generate feature information not only for a log entry in a record assigned with a training score but also for a log entry not included therein. In other words, for example, the feature extraction unit 2501 generates feature information also for a log entry not used as learning data in an analysis model (a log entry in a record not assigned with a training score). Typically, the feature extraction unit 2501 in this modified example 2 may generate feature information for each log entry in every record included in a log.

The pre-learning unit 2503 executes pre-learning related to a multilayer NN used as an analysis model by use of feature information being related to each log entry and being generated in the feature extraction unit 2501.

A specific method of pre-learning (pre-training) a multilayer NN may be appropriately selected including a known technology. For example, as a method of pre-learning, an autoencoder may be used or restricted Boltzmann machines (RBM) may be used. As an example, by decomposing the multilayer NN used as an analysis model into a plurality of single-layer networks for each layer and performing unsupervised learning using the aforementioned feature information with each layer as an autoencoder, the pre-learning unit 2503 can calculate a parameter of a node included in each layer. Without being limited to the above, for example, the pre-learning unit 2503 may appropriately employ another known pre-learning method (for example, a deep autoencoder or deep RBM). The pre-learning unit 2503 provides thus generated multilayer NN (specifically, a parameter in each node in the multilayer NN) for the analysis model generation unit 2502.

The analysis model generation unit 2502 adds a layer for regression (for example, an output layer including one output node) to a multilayer NN provided from the pre-learning unit 2503. Consequently, a network structure of the multilayer NN used as an analysis model is determined.

The analysis model generation unit 2502 executes learning processing using learning data and training data on the pre-learned analysis model generated as described above. Through the learning processing, the analysis model generation unit 2502 can fine-adjust a parameter of the analysis model to regression. Further, in order to suppress overlearning, a weight of a node in a lower layer of the multilayer NN may be fixed.

The other components in the analysis device 2500 may be similar to those according to the second example embodiment.

The analysis device 2500 in this modified example 2 configured as described above can generate an analysis model capable of more suitably determining an importance level of a log entry. The reason is that the pre-learning unit 2503 executes pre-learning related to an analysis model by use of feature information generated from a log recorded in an execution process of a sample 801. Through pre-learning, a suitable initial value can be given to a multilayer NN used as an analysis model. Consequently, the analysis device 2500 can generate a more suitable analysis model while avoiding various problems (for example, the vanishing gradient problem) in learning processing of a multilayer NN.

### Modified example 3 of Second Example Embodiment

A third modified example of the second example embodiment (described as a “modified example 3”) will be described below. A configuration similar to that according to each of the aforementioned example embodiments and modified examples is hereinafter given a similar reference sign, and detailed description thereof is omitted.

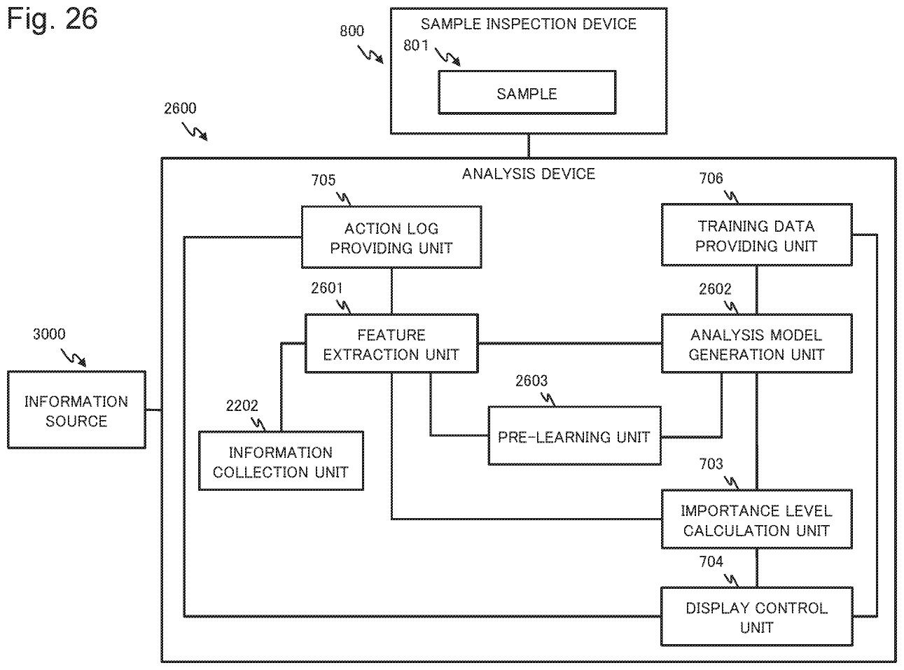

FIG. 26 is a block diagram conceptually illustrating a functional configuration of an analysis device 2600 in this modified example 3. The analysis device 2600 in this modified example 3 has a configuration combining the aforementioned modified example 1 and modified example 2. It is assumed in the present example embodiment that a multilayer NN is used as an analysis model, similarly to the aforementioned modified example 2.

A feature extraction unit 2601 according to the present example embodiment generates feature information including a third feature value extracted from external context information, similarly to the feature extraction unit 2201 in the aforementioned modified example 1. The other function of the feature extraction unit 2601 may be similar to that in the aforementioned modified example 1 and modified example 2.

A pre-learning unit 2603 executes pre-learning related to an analysis model by use of feature information including a third feature value. The other function of the pre-learning unit 2603 may be similar to that in the modified example 2.

By use of learning data including feature information including a third feature value, and training data, an analysis model generation unit 2602 executes learning processing related to an analysis model pre-learned by the pre-learning unit 2603. The other function of the analysis model generation unit 2602 may be similar to that in the aforementioned modified example 1 and modified example 2.

The other configuration of the analysis device 2600 may be similar to that in the aforementioned modified example 1 and modified example 2.

The analysis device 2600 configured as described above corresponds to a combination of the aforementioned modified example 1 and modified example 2, and can more suitably determine an importance level related to a log, similarly to the aforementioned modified example 1 and modified example 2.

### Configuration of Hardware and Software Program (Computer Program)

A hardware configuration capable of providing each of the example embodiments and modified examples described above will be described below. In the following description, the respective analysis devices (100, 700, 2200, 2500, 2600) described in the respective aforementioned example embodiments are collectively described as “analysis devices.”

Each analysis device described in each example embodiment may be configured with one or a plurality of dedicated hardware devices. In that case, each component illustrated in each of the aforementioned diagrams (for example, FIGS. 1, 7 to 9, 22, 25, 26) may be provided as a piece of hardware (such as an integrated circuit on which processing logic is implemented) integrating a part or the whole of the component. Specifically, for example, when an analysis device is provided by a hardware device, a component of the analysis device may be implemented as an integrated circuit (for example, a system on a chip [SoC]) capable of providing each function. In this case, for example, data held in a component in the analysis device may be stored in a random access memory (RAM) area or a flash memory area integrated on the SoC.

In this case, for example, the analysis device may be provided by use of one or more processing circuits capable of providing the functions of the feature extraction unit (101, 701, 2201, 2501, 2601), the analysis model generation unit (102, 702, 2502, 2602), the importance level calculation unit 703, the display control unit 704, the action log providing unit 705, the training data providing unit 706, the information collection unit 2202, and the pre-learning unit (2503, 2603), a communication circuit, a storage circuit, and the like. Further, various variations are assumed in implementation of a circuit configuration providing the analysis device.

When an analysis device is configured with a plurality of hardware devices, the hardware devices may be communicably connected to one another by a suitable communication method (wired, wireless, or a combination thereof).

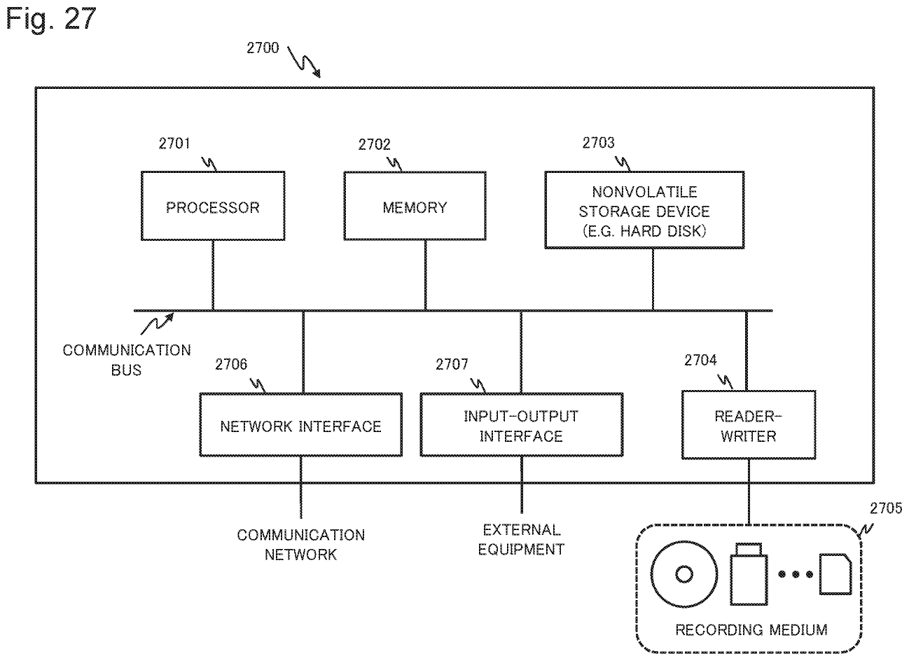

Further, the aforementioned analysis device may be configured with a general-purpose hardware device 2700 as illustrated in FIG. 27 and various software programs (computer programs) executed by the hardware device 2700. In this case, the analysis device may be configured with a suitable number (one or more) of hardware devices 2700 and software programs.

For example, a processor 2701 in FIG. 27 is a general-purpose central processing unit (CPU) or a microprocessor. For example, the processor 2701 may read various software programs stored in a nonvolatile storage device 2703, to be described later, into a memory 2702 and execute processing in accordance with the software programs. In this case, a component in the analysis device according to each of the aforementioned example embodiments may be provided as, for example, a software program executed by the processor 2701.

For example, the analysis device according to each of the aforementioned example embodiments may be provided by one or more programs capable of providing the functions of the feature extraction unit (101, 701, 2201, 2501, 2601), the analysis model generation unit (102, 702, 2502, 2602), the importance level calculation unit 703, the display control unit 704, the action log providing unit 705, the training data providing unit 706, the information collection unit 2202, and the pre-learning unit (2503, 2603). Further, various variations may be assumed in implementation of such programs.

The memory 2702 is a memory device, such as a RAM, that can be referred to by the processor 2701 and stores a software program, various data, and the like. The memory 2702 may be a volatile memory device.

For example, the nonvolatile storage device 2703 is a nonvolatile storage device such as a magnetic disk drive or a semiconductor storage device (such as a flash memory). The nonvolatile storage device 2703 may store various software programs, data, and the like. In the aforementioned analysis device, data stored in the action log providing unit 705 and the training data providing unit 706 may be stored in the nonvolatile storage device 2703.

For example, a reader-writer 2704 is a device processing a read and a write of data from and into a recording medium 2705, to be described later. For example, the analysis device may read a log recorded in the recording medium 2705 and training data through the reader-writer 2704.

For example, the recording medium 2705 is a recording medium capable of recording data, such as an optical disk, a magneto-optical disk, and a semiconductor flash memory. In the present disclosure, a type and a recording method (format) of a recording medium is not particularly limited and may be appropriately selected.

A network interface 2706 is an interface device connected to a communication network, and, for example, an interface device for wired and wireless local area network (LAN) connection, or the like may be employed. The analysis device may be communicably connected to the information source 3000 and the sample inspection device 800 through the network interface 2706.

An input-output interface 2707 is a device for controlling input and output from and to an external device. For example, the external device may be input equipment (for example, a keyboard, a mouse, and a touch panel) capable of receiving an input from a user. Further, for example, the external device may be output equipment (for example, a monitor screen and a touch panel) capable of presenting various outputs to a user. For example, the analysis device may control display of a user interface through the input-output interface.

For example, the technology according to the present disclosure may be provided by the processor 2701 executing a software program supplied to the hardware device 2700. In this case, an operating system, middleware such as database management software and network software, and the like that operate on the hardware device 2700 may execute part of the processing.

Each unit illustrated in each of the aforementioned diagrams, according to each of the aforementioned example embodiments, may be provided as a software module being a function (processing) unit of a software program executed by the aforementioned hardware. For example, when the respective aforementioned units are provided as software modules, the software modules may be stored in the nonvolatile storage device 2703. Then, when executing each type of processing, the processor 2701 may read the software modules into the memory 2702. Further, the software modules may be configured to be able to mutually convey various types of data by an appropriate method such as a shared memory or interprocess communication.

Further, each of the aforementioned software programs may be recorded in the recording medium 2705. In this case, each of the aforementioned software programs may be installed in the hardware device 2700 by use of a suitable jig (tool). Further, the various software programs may be downloaded from outside through a communication line such as the Internet. Various types of common procedures may be employed as a method of supplying a software program.

In such a case, the technology according to the present disclosure may be configured with a code constituting a software program or a computer readable recording medium having the code recorded thereon. In this case, the recording medium may be a non-transitory recording medium independent of the hardware device 2700 or a recording medium storing or temporarily storing a software program downloaded by transmission through a LAN, the Internet, or the like.

Further, the aforementioned analysis device or a component of the analysis device may be configured with a virtual environment virtualizing the hardware device 2700 illustrated in FIG. 27 and a software program (computer program) executed in the virtual environment. In this case, a component of the hardware device 2700 illustrated in FIG. 27 is provided as a virtual device in the virtual environment.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

The whole or part of the example embodiments disclosed above can be described as, but not limited to, the following supplementary notes.

### (Supplementary Note 1)

An analysis device comprising:

feature extraction means configured to be able to, by use of a first feature value extracted from a first log entry being a log entry in which information indicating an action of a software program is recorded and a second feature value being different from the first feature value and being extracted from one or more second log entries being log entries, generate feature information related to the first log entry; and

analysis model generation means configured to, by use of learning data including one or more sets of the feature information related to the first log entry and importance level information indicating an importance level assigned to the first log entry, generate an analysis model capable of determining an importance level related to another log entry.

### (Supplementary Note 2)

The analysis device according to Supplementary Note 1, wherein

the feature extraction means extracts, as the second feature value, context information being information generated by counting pieces of information respectively recorded in the second log entries.

### (Supplementary Note 3)

The analysis device according to Supplementary Note 2, wherein

a log type allowing identification of a type of processing concerning which the log entry is recorded is recorded in the log entry, and,

by use of information recorded in all the second log entries recorded with respect to the software program, the feature extraction means generates the context information by calculating one or more of:
information related to a number of the second log entries for each process executed in an execution of the software program;
information indicating a histogram in which a number of the second log entries is totalized for each of the log types; and
information related to a number of resources accessed in an execution of the software program, the number being totalized for each of the log types.

### (Supplementary Note 4)

The analysis device according to Supplementary Note 2, wherein

a log type allowing identification of a type of processing concerning which the log entry is recorded is recorded in the log entry, and,

by use of information recorded in a plurality of the second log entries recorded with respect to the same process as a process in which the first log entry is recorded, the feature extraction means generates the context information by calculating one or more of:
information indicating a histogram in which a number of the second log entries is totalized for each of the log types;
information related to a number of resources accessed in an execution of the software program, the number being totalized for each of the log types; and
information related to a ratio between a total number of the log entries recorded in an execution of the software program and a total number of the second log entries recorded with respect to the same process as a process in which the first log entry is recorded.

### (Supplementary Note 5)

The analysis device according to Supplementary Note 2, wherein

a log type allowing identification of a type of processing concerning which the log entry is recorded is recorded in the log entry, and,

by use of information recorded in a plurality of the second log entries recorded within a specific range in a time series from a timing at which the first log entry is recorded, the feature extraction means generates the context information by calculating one or more of:
information indicating a histogram in which a number of the second log entries is totalized for each of the log types; and
information related to a ratio between a total number of the plurality of the second log entries recorded within the specific range in the time series from the timing at which the first log entry is recorded and a total number of the second log entries recorded with respect to the same process as the first log entry out of the plurality of the second log entries recorded within the specific range in the time series from the timing at which the first log entry is recorded.

### (Supplementary Note 6)

The analysis device according to Supplementary Note 1, wherein

the feature extraction means extracts, as the second feature value, context information being information generated by use of a feature value extracted from information recorded in each of the second log entries.

### (Supplementary Note 7)

The analysis device according to any one of Supplementary Notes 1 to 6, wherein

the feature extraction means extracts a feature value similar to the first feature value for the first log entry from each of the second log entries and generates the second feature value by use of the feature value extracted from each of the second log entries.

### (Supplementary Note 8)

The analysis device according to Supplementary Note 7, wherein the feature extraction means

extracts the first feature value from data expressing, by use of at least either of a character string and a numerical value, information recorded in the first log entry, and

generates integrated data by integrating data expressing, by use of at least either of a character string and a numerical value, information recorded in the second log entry for all the second log entries and generates the second feature value by extracting, from the integrated data, a feature value similar to the first feature value for the first log entry.

### (Supplementary Note 9)

The analysis device according to Supplementary Note 1, wherein

the feature extraction means extracts the second feature value from summary information indicating a result of analyzing the action of the software program by an analysis device capable of analyzing the action of the software program.

### (Supplementary Note 10)

The analysis device according to Supplementary Note 9, wherein

the feature extraction means extracts, as the second feature value, information being included in the summary information and indicating whether or not the software program executes one or more specific activities.

### (Supplementary Note 11)

The analysis device according to any one of Supplementary Notes 1 to 10, further comprising

information collection means configured to acquire, from an information source, information related to information recorded in the first log entry, as external context information, wherein

the feature extraction means
extracts a third feature value, based on external context information acquired by the information collection means, and
generates the feature information related to the first log entry by use of at least either of the second feature value and the third feature value, and the first feature value.

### (Supplementary Note 12)

The analysis device according to Supplementary Note 11, wherein

the information collection means collects, from the information source, information indicating a security-related reputation of a resource accessed in an execution of the software program, as the external context information.

### (Supplementary Note 13)

The analysis device according to Supplementary Note 11, wherein,

when access to a file is recorded in the first log entry,

the information collection means acquires, from the information source, one or more of:
information indicating whether or not the file is a file detected as malware;
information indicating an acquisition count of the file; and
information indicating a confidence level of the file, as the external context information.

### (Supplementary Note 14)

The analysis device according to Supplementary Note 11, wherein,

when access to a registry is recorded in the first log entry,

the information collection means acquires, from the information source, information indicating whether or not the registry is accessed by malware, as the external context information.

### (Supplementary Note 15)

The analysis device according to Supplementary Note 11, wherein,

when a communication to a communication destination is recorded in the first log entry,

the information collection means acquires, from the information source, information indicating a security-related reputation of the communication destination, as the external context information.

### (Supplementary Note 16)

The analysis device according to Supplementary Note 1 or 2, wherein

a log type allowing identification of a type of processing concerning which the log entry is recorded is recorded in the log entry, and

the analysis model generation means individually generates the analysis model for each of the log types by use of the feature information generated for the log entry corresponding to each of the log types.

### (Supplementary Note 17)

The analysis device according to any one of Supplementary Notes 1 to 16, further comprising:

importance level calculation means configured to calculate an importance level related to the log entry by use of the analysis model; and

display control means configured to generate a user interface allowing control of a display method of the log entry, based on an importance level calculated for the log entry.

### (Supplementary Note 18)

The analysis device according to Supplementary Note 17, wherein

the display control means generates the user interface including a control element allowing setting of a threshold indicating an importance level of the displayed log entry, and

the user interface displays the log entry whose importance level is calculated to be equal to or greater than the threshold and the log entry whose importance level is calculated to be less than the threshold, by use of display methods different from each other.

### (Supplementary Note 19)

The analysis device according to Supplementary Note 18, wherein

the display control means generates the user interface including the control element allowing setting of the threshold indicating the importance level of the displayed log entry, and

the user interface displays the log entry whose importance level is calculated to be equal to or greater than the threshold and suppresses display of the log entry whose importance level is calculated to be less than the threshold.

### (Supplementary Note 20)

The analysis device according to Supplementary Note 19, wherein

the display control means generates the user interface including the control element allowing setting of the threshold indicating the importance level of the displayed log entry, and

the user interface displays the log entry whose importance level is calculated to be the threshold in a more highlighted manner than the log entry whose importance level is calculated to be less than the threshold.

### (Supplementary Note 21)

The analysis device according to any one of Supplementary Notes 1 to 20, wherein

the analysis model is a neural network including a plurality of layers,

the feature extraction means generates the feature information for the log entry not assigned with the importance level information, and

the analysis model generation means executes pre-learning related to the analysis model by use of both of the feature information generated for the log entry not assigned with the importance level information and the feature information generated for the first log entry assigned with the importance level information.

### (Supplementary Note 22)

A log analysis method comprising:

by use of a first feature value extracted from a first log entry being a log entry in which information indicating an action of a software program is recorded and a second feature value being different from the first feature value and being extracted from one or more second log entries being log entries, generating feature information related to the first log entry; and,

by use of learning data including one or more sets of the feature information related to the first log entry and importance level information indicating an importance level assigned to the first log entry, generating an analysis model capable of determining an importance level related to another log entry.

### (Supplementary Note 23)

A recording medium having an analysis program recorded thereon, the analysis program causing a computer to execute:

processing of, by use of a first feature value extracted from a first log entry being a log entry in which information indicating an action of a software program is recorded and a second feature value being different from the first feature value and being extracted from one or more second log entries being log entries, generating feature information related to the first log entry; and

processing of, by use of learning data including one or more sets of the feature information related to the first log entry and importance level information indicating an importance level assigned to the first log entry, generating an analysis model capable of determining an importance level related to another log entry.

### REFERENCE SIGNS LIST

100 Analysis device
101 Feature extraction unit
102 Analysis model generation unit
700 Analysis device
701 Feature extraction unit
702 Analysis model generation unit
703 Importance Level Calculation unit
704 Display control unit
705 Action log providing unit
706 Training data providing unit
2200 Analysis device
2201 Feature extraction unit
2202 Information collection unit
2500 Analysis device
2501 Feature extraction unit
2502 Analysis model generation unit
2503 Pre-learning unit
2600 Analysis device
2601 Feature extraction unit
2602 Analysis model generation unit
2603 Pre-learning unit
2701 Processor
2702 Memory
2703 Nonvolatile storage device
2704 Reader-writer
2705 Recording medium
2706 Network interface
2707 Input-output interface

1. An analysis device comprising:
a memory storing instructions; and
one or more processors configured to execute the instructions to:
be able to, by use of a first feature value extracted from a first log entry being a log entry in which information indicating an action of a software program is recorded and a second feature value being different from the first feature value and being extracted from one or more second log entries being log entries, generate feature information related to the first log entry; and
by use of learning data including one or more sets of the feature information related to the first log entry and importance level information indicating an importance level assigned to the first log entry, generate an analysis model capable of determining an importance level related to another log entry.

2. The analysis device according to claim 1, wherein the one or more processors are further configured to execute the instructions to extract,
as the second feature value, context information being information generated by counting pieces of information respectively recorded in the second log entries.

3. The analysis device according to claim 2, wherein
a log type allowing identification of a type of processing concerning which the log entry is recorded is recorded in the log entry, and,
the one or more processors are further configured to execute the instructions to, by use of information recorded in all the second log entries recorded with respect to the software program, generate the context information by calculating one or more of:
information related to a number of the second log entries for each process executed in an execution of the software program;
information indicating a histogram in which a number of the second log entries is totalized for each of the log types; and
information related to a number of resources accessed in an execution of the software program, the number being totalized for each of the log types.

4. The analysis device according to claim 2, wherein
a log type allowing identification of a type of processing concerning which the log entry is recorded is recorded in the log entry, and,
the one or more processors are further configured to execute the instructions to, by use of information recorded in a plurality of the second log entries recorded with respect to the same process as a process in which the first log entry is recorded, generate the context information by calculating one or more of:
information indicating a histogram in which a number of the second log entries is totalized for each of the log types;
information related to a number of resources accessed in an execution of the software program, the number being totalized for each of the log types; and
information related to a ratio between a total number of the log entries recorded in an execution of the software program and a total number of the second log entries recorded with respect to the same process as a process in which the first log entry is recorded.

5. The analysis device according to claim 2, wherein
a log type allowing identification of a type of processing concerning which the log entry is recorded is recorded in the log entry, and,
the one or more processors are further configured to execute the instructions to, by use of information recorded in a plurality of the second log entries recorded within a specific range in a time series from a timing at which the first log entry is recorded, generate the context information by calculating one or more of:
information indicating a histogram in which a number of the second log entries is totalized for each of the log types; and
information related to a ratio between a total number of the plurality of the second log entries recorded within the specific range in the time series from the timing at which the first log entry is recorded and a total number of the second log entries recorded with respect to the same process as the first log entry out of the plurality of the second log entries recorded within the specific range in the time series from the timing at which the first log entry is recorded.

6. The analysis device according to claim 1, wherein
the one or more processors are further configured to execute the instructions to extract, as the second feature value, context information being information generated by use of a feature value extracted from information recorded in each of the second log entries.

7. The analysis device according to claim 1, wherein
the one or more processors are further configured to execute the instructions to:
extract a feature value similar to the first feature value for the first log entry from each of the second log entries and
generate the second feature value by use of the feature value extracted from each of the second log entries.

8. The analysis device according to claim 7, wherein
the one or more processors are further configured to execute the instructions to:
extract the first feature value from data expressing, by use of at least either of a character string and a numerical value, information recorded in the first log entry, and
generate integrated data by integrating data expressing, by use of at least either of a character string and a numerical value, information recorded in the second log entry for all the second log entries and generates the second feature value by extracting, from the integrated data, a feature value similar to the first feature value for the first log entry.

9. The analysis device according to claim 1, wherein
the one or more processors are further configured to execute the instructions to extract the second feature value from summary information indicating a result of analyzing the action of the software program by an analysis device capable of analyzing the action of the software program.

10. The analysis device according to claim 9, wherein
the one or more processors are further configured to execute the instructions to extract, as the second feature value, information being included in the summary information and indicating whether or not the software program executes one or more specific activities.

11. The analysis device according to claim 1, wherein
the one or more processors are further configured to execute the instructions to:
acquire, from an information source, information related to information recorded in the first log entry, as external context information,
extract a third feature value, based on external context information, and
generate the feature information related to the first log entry by use of at least either of the second feature value and the third feature value, and the first feature value.

12. The analysis device according to claim 11, wherein
the one or more processors are further configured to execute the instructions to collect, from the information source, information indicating a security-related reputation of a resource accessed in an execution process of the software program, as the external context information.

13. The analysis device according to claim 11, wherein,
the one or more processors are further configured to execute the instructions to, when access to a file is recorded in the first log entry, acquire, from the information source, one or more of:
information indicating whether or not the file is a file detected as malware;
information indicating an acquisition count of the file; and
information indicating a confidence level of the file,
as the external context information.

14. The analysis device according to claim 11, wherein,
the one or more processors are further configured to execute the instructions to, when access to a registry is recorded in the first log entry, acquire, from the information source, information indicating whether or not the registry is accessed by malware, as the external context information.

15. The analysis device according to claim 11, wherein,
the one or more processors are further configured to execute the instructions to, when a communication to a communication destination is recorded in the first log entry, acquire, from the information source, information indicating a security-related reputation of the communication destination, as the external context information.

16. The analysis device according to claim 1, wherein
a log type allowing identification of a type of processing concerning which the log entry is recorded is recorded in the log entry, and
the one or more processors are further configured to execute the instructions to individually generate the analysis model for each of the log types by use of the feature information generated for the log entry corresponding to each of the log types.

17. The analysis device according to claim 1, wherein
the one or more processors are further configured to execute the instructions to:
calculate an importance level related to the log entry by use of the analysis model; and
generate a user interface allowing control of a display method of the log entry, based on an importance level calculated for the log entry.

18. The analysis device according to claim 17, wherein
the one or more processors are further configured to execute the instructions to generate the user interface including a control element allowing setting of a threshold indicating an importance level of the displayed log entry, and
the user interface displays the log entry whose importance level is calculated to be equal to or greater than the threshold and the log entry whose importance level is calculated to be less than the threshold, by use of display methods different from each other.

19-21. (canceled)

22. A log analysis method comprising:
by use of a first feature value extracted from a first log entry being a log entry in which information indicating an action of a software program is recorded and a second feature value being different from the first feature value and being extracted from one or more second log entries being log entries, generating feature information related to the first log entry; and,
by use of learning data including one or more sets of the feature information related to the first log entry and importance level information indicating an importance level assigned to the first log entry, generating an analysis model capable of determining an importance level related to another log entry.

23. A non-transitory recording medium having an analysis program recorded thereon, the analysis program causing a computer to execute:
processing of, by use of a first feature value extracted from a first log entry being a log entry in which information indicating an action of a software program is recorded and a second feature value being different from the first feature value and being extracted from one or more second log entries being log entries, generating feature information related to the first log entry; and
processing of, by use of learning data including one or more sets of the feature information related to the first log entry and importance level information indicating an importance level assigned to the first log entry, generating an analysis model capable of determining an importance level related to another log entry.
